(19) United States
(12) Patent Application Publication
(10) Pub. No.: US 2017/0070081 A1
(43) Pub. Date: Mar. 9, 2017

(54) HYBRID STORAGE SYSTEM

(71) Applicant: Robert Bosch GmbH, Stuttgart (DE)

(72) Inventors: Jingting Cher, Singapore (SG); Annika Carolin Kufner, Neunkirchen am Brand (DE); Falco Sengebusch, Singapore (SG); Sumedha Chouthe, Singapore (SG); Xingchi Wang, Singapore (SG); Yanlin Li, Shanghai (CN)

(21) Appl. No.: 15/123,158

(22) PCT Filed: Mar. 6, 2014
(86) PCT No.: PCT/IB2014/059483

§ 371 Date: Sep. 1, 2016

(51) Int. Cl. H02J 7/04; H02S 40/32; H02J 7/35; H02S 40/38

(52) U.S. Cl. CPC H02J 7/045; H02S 40/38; H02S 40/32; H02J 7/35

(57) ABSTRACT

A battery charging apparatus. The apparatus includes two or more hybrid battery charging devices. Each hybrid battery charging device includes input terminals for connecting a photovoltaic panel, first battery connections for connecting a lead-acid battery, second battery connections for connecting a high-cycle chemical battery, a two-way DC/DC converter, a charge and discharge control system, which is connected to the two-way DC/DC converter, and output terminals for connecting a load.

### FIELD

The present invention relates to a hybrid storage system for a remote energy system (RES).

### BACKGROUND INFORMATION

Lead acid batteries have been used generally for years as the main storage medium in off-grid solar systems and in remote energy systems (RES). The popularity of lead acid batteries is mainly motivated by their low purchasing price. However, over the total lifetime of a RES, the lead-acid battery often becomes the main cost driver since the lead acid battery has to be changed every 1 to 3 years resulting in high costs for acquiring and changing several batteries. This relatively short lifetime, compared, for example, to lead acid batteries in back-up systems, is due to the nature of remote energy applications. For example, in an off-grid solar system a battery is partly charged during daytime for several hours depending on the geographic location and on the weather and mainly discharged during night time, for example for running light bulbs, for running a TV set, or for other equipment and machinery. Due to these conditions, the lead-acid battery remains most of the time in a low state of charge (SOC) and it is rarely fully charged. These aspects affect the capacity of a lead-acid battery since they tend to increase the sulfation process in a lead acid battery.

U.S. Pat. No. 6,353,304 describes providing two battery strings, which can be connected to an AC power source via AC/DC converters and switches, such that one battery string is loaded while the other battery string is discharged. This arrangement can provide an improved battery management for solar hybrid systems that have a generator besides the solar cells.

### SUMMARY

It is an object of the present invention to provide an improved battery charging apparatus.

In accordance with the present invention, an improved battery charging apparatus is provided that includes two or more hybrid battery charging devices.

Each hybrid battery-charging device has input terminals for connecting a photovoltaic panel and first battery connections for connecting a lead-acid battery. A lead acid battery according to the application comprises various types such as a liquid acid battery, a lead-gel battery, or an absorbent glass mat (AGM) lead acid battery. The lead acid battery is also called a lead battery.

Furthermore, the battery-charging device comprises second battery connections for connecting a high cycle chemical battery. Preferentially, a lithium battery such as a lithium-ion battery or a lithium polymer battery provides the high cycle chemical battery but other high cycle chemical batteries such as a Nickel-Iron battery may also be used.

Within the context of the present application, a “chemical battery” refers to a battery in which a charging or discharging of the battery involves the movement of ions and chemical reactions at the respective electrodes of the battery. This stands in contrast to capacitors such as plate capacitors, electrolytic capacitors or double layer capacitors, which are also known as super-capacitors, wherein charging or discharging merely involves the rearrangement of electrons or of other charged particles without a chemical reaction taking place. Furthermore, a high-cycle chemical battery according to the application is a rechargeable battery.

According to the present invention, the characteristics of a high-cycle chemical battery complement the characteristics of the lead-acid battery. The lead-acid battery is well adapted to being fully charged or even slightly overcharged while the high-cycle chemical battery is well adapted to a deeper discharge level. Lead acid-batteries are relatively inexpensive and are often used for remote energy systems. Such a lead-acid battery can even be provided by a simple car battery but it is more advantageous to use specially adapted batteries which tolerate deeper discharges.

The battery-charging device comprises a two-way DC/DC converter, which is also known as bidirectional DC/DC converter. The two-way DC/DC converter is used to charge the lithium battery in a first current direction as well as to discharge the lithium battery in a second current direction.

A first set of terminals of the two-way DC/DC converter is connected with the second battery connections and a second set of terminals of the two-way DC/DC converter is connected with the first battery connections. An input to the second set of terminals is derived from the input terminals of the hybrid battery-charging device. Herein, an input of B being “derived” from A means that B receives an input from A, wherein the input may be transmitted from A to B directly via an electric line or indirectly via other components such as switches, transistors etc.

Furthermore, a charge and discharge control system is provided, which is connected to the two-way DC/DC converter via respective control lines and output terminals for connecting a electrical resistive load. An input of the output terminals is derived from the first battery connections via a connecting means for connecting the output terminals to the first battery connections, such as a magnetic switch or a semiconductor switch.

In the direct current circuits of the hybrid battery charging device, either one of the poles may be connected to a common ground in a known way. For example, a minus pole connection of the first battery connections and a minus pole terminal of the output terminals may be connected to a common ground potential. In other words, one of the respective battery connections and one of the output terminals may be provided by respective connections to the common ground potential. The input terminals of the two-way DC/DC converter are also referred to as “system terminals” and the voltage across the system terminals is also referred to as “system voltage”.

In aspect of the prevent invention, the output terminals of the hybrid battery charging devices are connected in parallel.

This allows the output terminals of the hybrid battery charging devices to be connected to one lead-acid battery. This avoids unbalanced current distribution, which can occur in an arrangement of several lead-acid batteries, and not one lead-acid battery. The unbalanced current distribution can require expensive circuit and switch design circuit for managing the current distribution.

The input terminals of the hybrid battery charging devices can be connected in series.

This arrangement has an advantage of reducing electrical cables for connecting the photovoltaic panels. The photovoltaic panels are normally installed on a rooftop while the hybrid battery charging devices are normally installed on ground level. This arrangement requires two wires, instead of four or more wires, for connecting the photovoltaic panels to the hybrid battery charging devices.

The battery charging apparatus often include the high-cycle chemical battery for easy implementation.

In one implementation, the high-cycle chemical battery comprises a lithium battery.

Furthermore, the hybrid battery-charging device may comprise a control device such as a controlled on/off switch, a pulse width modulation (PWM), a maximum power point tracker, etc. for better controlling the charge voltage of the batteries. The control device is connected between the input terminal of the system and input terminals of the DC/DC converter, which are in turn connected to terminals of the lead-acid battery. Furthermore, the control device is connected to the charge and discharge control system via control lines. For example, the control lines may be configured for switching transistors of a PWM in the control device.

The two-way DC/DC converter may comprise, for example, a buck-boost converter, a buck converter, or a boost converter for providing a suitable voltage ratio for charging or discharging the lithium battery. Especially, the two-way DC/DC converter may comprise a step-up converter for providing a higher voltage to the lithium battery than the end-of-charge voltage of the lead-acid battery.

In particular, the two-way DC/DC converter may comprise at least two semiconductor switches, wherein respective input connections of the transistors are connected to the charge control system via respective control lines. In this way, the two-way DC/DC converter is easy to control via electric signals. In particular, the transistors may be realized as power transistors.

Furthermore, the hybrid battery-charging device may comprise first and second voltage measuring connections for connecting first and second voltage sensors. The first voltage sensor is connected to terminals of the lead-acid battery and the first voltage measuring connections are connected to the charge and discharge control system. The second voltage sensor is connected to terminals of the lithium battery and the second voltage measuring connections are connected to the charge and discharge control system, wherein the connection may be direct or also indirect via a separate controller for managing the state of charge of the lithium battery such as a voltage-monitoring chip. The voltage-monitoring chip may be connected to the voltage sensor of the lithium battery and to the charge control system via a control line.

In particular, the lithium battery, the two-way DC/DC converter, and the voltage-monitoring chip for the lithium battery may be mounted together in an energy storage subsystem, wherein the energy storage subsystem provides input terminals for plugging the energy storage subsystem into the hybrid battery-charging device. Thereby, the building block comprising the lithium battery can be used and serviced separately from the rest of the hybrid battery-charging device.

The first and second voltage sensors may be provided as components of the hybrid battery-charging device, for example within the charge and discharge control system or they may be provided as components of the respective batteries.

The hybrid battery-charging device may furthermore comprise a separate battery management system for the lithium battery, the separate battery management system that is connected to the charge and discharge control system. In this way, an existing battery-charging device, for example a battery-charging device for a lithium battery, or parts of it, may be used in the hybrid battery-charging device according to the present invention.

One battery management system of one hybrid battery charging device can be provided as a master controller while the other battery management system of the other hybrid battery-charging device is provided as a slave controller.

The master controller provides synchronization control signals to the slave controller such that the management of the respective lithium batteries are done essentially at the same time. The management can refer to the charging of the lithium batteries or to the discharging of the lithium batteries.

A control line allows the master controller to send commands or control signals to the slave controller. After this, the slave controller follows the master controller with respect to charging and discharging of the lithium batteries.

The charging step and the discharging step can be separated by a time delay for avoiding or preventing oscillation of the charging or discharging electrical current and voltage.

The present invention also provides an improved hybrid storage system. The storage system includes the above battery charging apparatus, which comprises at least two hybrid-battery charging devices, and a lead-acid battery being connected to the battery charging apparatus.

The hybrid battery-charging device often comprises a high-cycle chemical battery.

Furthermore, the hybrid storage system may further comprise a capacitor such as an ultra-capacitor, which is connected electrically in parallel to the lithium battery, for a fast response to high load peaks of a connected load.

Furthermore, in accordance with the present invention, a hybrid storage system is provided with a hybrid-charging device according to the application that further comprises a lead-acid battery that is connected to the first battery connections.

The hybrid storage system may comprise furthermore a first voltage sensor, which is connected to a terminal or to terminals of the first battery and to the charge and discharge control system, and a second voltage sensor, which is connected to a terminal or to terminals of the second voltage battery and to the charge and discharge control system.

Furthermore, in accordance with the present invention, a method is provided for charging a lead acid battery and a lithium battery of a hybrid storage system by an electric power source such as a photovoltaic panel.

According to the present invention, a lead-acid battery is charged in a first battery charging phase until the lead-acid battery has reached a first pre-determined state of charge. During the first battery charging phase, in which the lead-acid battery is charged, the charging may be controlled just by limiting to a maximum current or to perform unlimited charging or bulk charging, for example by a PID controller which uses the charging voltage and current as input data.

In an equalization phase, which is also known as a topping or boost phase, the lead-acid battery and the lithium battery are both charged until the lead-acid battery has reached a second pre-determined state of charge. In addition, the lead-acid battery and the lithium battery may also be charged during an “absorption phase” or a boost phase of the lead-acid battery. In the equalization and absorption phases, the system voltage is kept constant at different set points, which correspond to the phases.

During the equalization phase, an applied voltage at the lead-acid battery can be made to oscillate between a pre-determined lower voltage and a pre-determined upper voltage. In particular, the voltage may be applied by pulse charging, and especially by pulse-width modulated charging. The voltage of the charge pulses may be higher than the end of charge voltage of the lead-acid battery. The charge pulse can contribute to a higher charge and life expectancy of the lead-acid battery by equalizing the charges on the battery cells, mixing the electrolyte, and reducing the sulfation. Furthermore, a mean voltage at terminals of the lead-acid battery is close to an end-of-charge voltage of the lead-acid battery during the equalization phase. During the equalization phase, the charge current to the lead-acid battery will decrease because the charge state of the lead-acid battery approaches 100%.

The lithium battery is charged in a third battery charging phase during which an essentially constant system voltage is applied to system terminals of the lead-acid battery and the first voltage is converted into a charging voltage at terminals of the lithium battery.

Advantageously, the essentially constant system voltage that is applied to the system terminals during the charging of the lithium battery in the third battery-charging phase is made equal to a maximum open circuit voltage of the lead-acid battery. Thereby, the lead-acid battery will not discharge significantly, even if it remains connected to the lithium battery. On the other hand, an overcharging of the lead-acid battery is avoided by keeping the terminals of the lead-acid battery at its maximum open circuit voltage. In addition, a trickle or standby charge may be applied to the lead-acid battery during which the applied voltage may be higher than the maximum open circuit voltage of the lead-acid battery.

Furthermore, in accordance with the present invention, a method is provided for discharging a lead-acid battery and a lithium battery of a hybrid storage system. According to the present invention, a load is supplied with power by discharging the lithium battery via system terminals of the lead acid battery. The voltage at the system terminals is then maintained essentially equal to a maximum open circuit voltage of the lead-acid battery until a voltage at terminals of the lithium battery has reached an end-of-discharge voltage of the lithium battery.

Thereby, it is not required to provide a direct connection between the lithium battery and the load. This ensures that the lead-acid battery is not already discharged, even if it is not disconnected. A controlled DC/DC converter can provide the required voltage, for example.

If the output voltage of the lithium battery has reached an end-of-discharge voltage of the lithium battery, the lead-acid battery is discharged until the voltage of the lead-acid battery has reached an end-of-discharge voltage of the lead-acid battery. The end-of-discharge voltage of the lead-acid battery is a voltage to which the lead-acid battery can be discharged safely. The end-of-discharge voltage of the lead-acid battery corresponds to a SOC of about 30-40% of the lead-acid battery.

Similarly, if a load draws current from the lithium battery such that a voltage at terminal of the lead-acid battery drops below a maximum open circuit voltage of the lead-acid battery, the lead-acid battery is discharged in parallel with the lithium battery until the lithium battery has reached an end-of-discharge voltage.

In addition, the lead-acid battery may be disconnected after discharging the lead-acid battery and/or the hybrid storage system may enter a standby mode until it is determined that an electric power source can supply enough power to load the first battery. The disconnection of the lead-acid battery may be achieved by an on/off switch for disconnecting the load and/or achieved by a separate on/off switch, which is provided at the lead-acid battery. In particular, the standby mode may provide a reduced power consumption by suspending measurements of a system voltage at terminals of the first battery and of a voltage at terminals of the second battery.

Furthermore, in accordance with the present invention, a hybrid battery-charging device is provided wherein the charge and discharge control system is operative for executing a charge or a discharge method according to the application. This may be realized for example by providing a computer readable program of a programmable microcontroller or a special purpose circuit, which is provided in the charge and discharge control device of the hybrid battery-charging device.

In general, a hybrid storage system according to the present invention may be used wherever there is a need for an efficient intermediate storage of energy from an energy source. This applies in particular to energy systems in which a supply from an energy source and/or an energy demand of an energy consumer varies over time. More specifically, these conditions apply for off-grid applications, which are supplied by a varying energy source such as solar energy or wind energy. An off-grid solar power station with a hybrid storage system according to the application may be used, for example, in remote geographical locations such as the interior of Africa or Brazil. Furthermore, it can also be used for powering installations that are typically located outside of agglomerations such as communication antennas, weather stations, fire observation towers, emergency shelters, devices in outer space etc.

The present invention provides a further improved battery charging apparatus.

The battery charging apparatus includes one or more hybrid battery charging devices.

The hybrid battery charging device comprises input terminals, first battery connections, second battery connections, a two-way DC/DC converter with an adjustable voltage conversion ratio, a charge and discharge control system, and output terminals.

In particular, the input terminals are provided for connecting to a photovoltaic panel. The first battery connections are provided for connecting to a lead-acid battery. The second battery connections are provided for connecting to a high-cycle chemical battery.

A first set of terminals of the two-way DC/DC converter is connected with the second battery connections while a second set of terminals of the two-way DC/DC converter is connected with the first battery connections. The charge and discharge control system is connected to the two-way DC/DC converter via respective control lines. The output terminals are provided for connecting to a resistive load, wherein an input to the output terminals is derived from the first battery connections.

The charge and discharge control system includes a first device, a second device, and a processor.

In detail, the first device is provided for providing at least one electrical measurement of the first battery connections, which is provided for connecting to the lead-acid battery. The second device is provided for providing at least one electrical measurement of the second battery connections, which is provided for connecting to the high-cycle chemical battery.

The processor is adapted to control or adjust the voltage conversion ratio of the two-way DC/DC converter according to the at least one lead-acid battery electrical measurement and the at least one high-cycle chemical battery electrical measurement.

This processor provides a means of controlling the charging and discharging of the lead-acid battery and the high-cycle chemical battery. Once installed, this means can operate independently and reliably without need of a supervisory system.

In a general sense, the voltage conversion ratio can refer to step up ratio, wherein its output voltage is less than its input voltage, or to a step down ratio, wherein its output voltage is more than its input voltage.

The first device usually comprises a voltage measurement device for providing a voltage measurement of the lead-acid battery and/or an electrical current measurement device for providing an electrical current measurement of the lead-acid battery.

Similarly, the second device often comprises a voltage measurement device for providing of the high-cycle chemical battery and/or an electrical current measurement device of the high-cycle chemical battery.

The processor is often provided with a pre-determined voltage value. A DIP switch can be used as a means for allowing a user to select one pre-determined voltage value for a list of predetermined voltage values.

The processor is then adapted to control the two-way DC/DC converter according to a pre-determined voltage value.

The hybrid battery charging devices can comprise a stack or a group of hybrid battery charging devices that includes at least two hybrid battery charging devices.

Different ways of the connecting together the hybrid battery charging devices are possible. Output terminals of the at least two hybrid battery charging devices can be connected in parallel or in series.

The present invention also provides a hybrid storage system.

The hybrid storage system includes the above described battery charging apparatus, wherein the battery charging apparatus comprise at least one hybrid battery charging device.

The hybrid storage system also includes a high-cycle chemical battery, which is connected to second battery connections of each hybrid battery charging device.

The high-cycle chemical battery often comprises a lithium battery.

The hybrid storage system can also include a capacitor, which is connected in parallel to the high-cycle chemical battery for reducing or removing current spikes.

The hybrid storage system can also include a lead-acid battery that is connected to first battery connections of the hybrid battery charging device.

The present invention also provides a method of operating a battery charging apparatus, wherein the battery charging apparatus comprising at least one hybrid battery charging device.

The method includes a step of measuring a lead acid battery. After this, a high-cycle chemical battery is measured. A first set of terminals of a two-way DC/DC converter is connected with the high-cycle chemical battery, and a second set of terminals of the two-way DC/DC converter is connected with the lead acid battery.

A voltage conversion ratio of the two-way DC/DC converter is later adjusted according to the lead-acid battery electrical measurement and to the high-cycle chemical battery electrical measurement.

The measurement of the lead acid battery can include a step of measuring a voltage of the lead acid battery and/or a step of measuring an electrical current of the lead acid battery.

Similarly, the measurement of the lithium battery can comprise a step of measuring a voltage of the lithium battery and/or a step of measuring an electrical current of the lithium battery.

The present invention is explained in further detail below with respect to the following figures.

### BRIEF DESCRIPTION OF THE DRAWINGS

FIG. 1 shows a general layout of a hybrid storage system according to the present invention.

FIG. 2 shows a detailed view of the layout of FIG. 1.

FIG. 3 shows a circuit diagram of the hybrid storage system of FIGS. 1 and 2.

FIG. 4 shows state of charge curves for a 12 volt lead-acid battery of the storage system of FIG. 1 under different conditions.

FIG. 5 shows a system voltage, a state of charge of a lead-acid battery and a state of charge of a lithium battery of the hybrid storage system of FIG. 1 during typical charging and discharging processes.

FIG. 6 shows further parameters of the hybrid storage system of FIG. 1 for a discharge process for a high load.

FIG. 7 shows a flow diagram of a charging and a discharging process of the storage system of FIG. 1.

FIG. 8 shows another hybrid storage system with a first hybrid battery-charging device.

FIG. 9 shows a further hybrid storage system with a second hybrid battery-charging device.

FIG. 10 shows three further hybrid storage systems connected electrically in parallel to one common lead acid battery.

FIG. 11 shows the three further hybrid storage systems of FIG. 10 with a load directly connected to a lead acid battery.

FIG. 12 shows the three hybrid storage systems of FIG. 10 being connected electrically in parallel to a load, each hybrid storage system being connected to a separate lead acid battery.

FIG. 13 shows the three hybrid storage systems of FIG. 10 with photovoltaic panels being connected electrically in series.

FIG. 14 shows the three hybrid storage systems of FIG. 10 with master and slave controllers.

FIG. 15 shows the three hybrid storage systems of FIG. 10 with individual controllers.

FIG. 16 shows an embodiment of the individual controller of FIG. 15.

FIG. 17 shows a flow chart of a method of operating the embodiment of FIG. 16.

### DETAILED DESCRIPTION OF EXAMPLE EMBODIMENTS

Below, details are provided to describe embodiments of the present invention. It shall be apparent to one skilled in the art, however, that the embodiments may be practiced without such details.

Some parts of the embodiments are similar. The similar parts may have the same names or similar part numbers. The description of one part also applies by reference to another similar part, where appropriate, thereby reducing repetition of text without limiting the present invention.

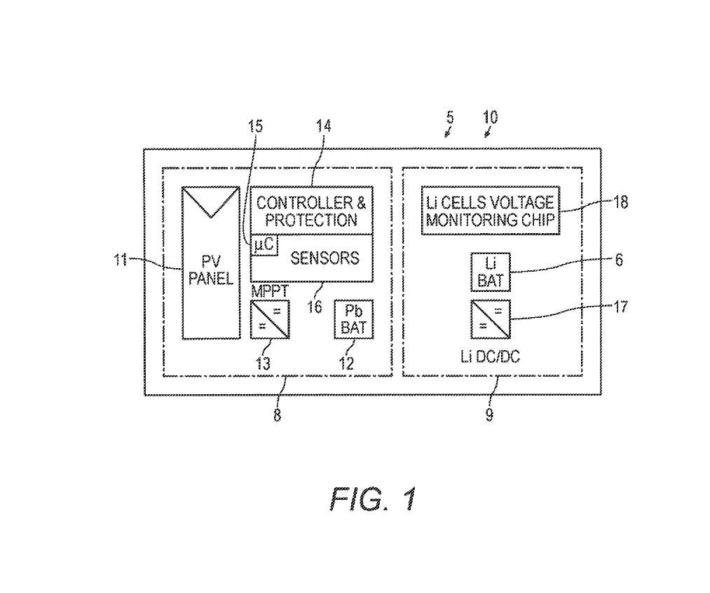

FIG. 1 shows a layout of a hybrid storage system 5 with a hybrid battery-charging device 10. According to the present invention, the hybrid storage system 5 comprises at least one battery while a hybrid battery-charging device does not necessarily include the batteries.

The hybrid storage system 5 comprises a first energy storage subsystem 8 with a photovoltaic panel 11, and a second energy storage subsystem 9. The first energy storage subsystem 8 comprises a lead acid battery 12, a unidirectional DC/DC converter 13, and a charge control system 14. The charge control system 14 comprises a microcontroller 15 and sensors 16. The sensors 16 comprise a voltage sensor at the terminals of the lead-acid battery 12. The DC/DC converter 13 is connected to a maximum power point tracker (MPPT). The maximum power point tracker provides an impedance matching for the photovoltaic panel 11 and it may be realized by a portion of the charge control system 14 and further hardware components.

Typically, the MPPT uses a measurement of the voltage across the photovoltaic panel 11, a measurement of an electrical current from the photovoltaic panel 11 and, optionally, further measurements to generate control signals corresponding to a reference voltage and/or to a reference current. MPPT algorithms comprise constant voltage, perturb and observe and incremental conductance algorithms.

Especially for remote energy systems with higher output powers (e.g. above 300 Watt) it is advantageous to use a maximum power point tracker (MPPT) in a system according to the application. Thereby, it is possible to achieve high efficiencies. However, a system according to the application can also be operated as with an off-grid solar system without an MPPT or input-DC/DC converter 13.

The second energy storage subsystem 9 comprises a lithium battery 6, a bidirectional DC/DC converter 17 and a voltage monitoring chip 18. The DC/DC converters 13 and 17 may be implemented in various ways, for example as buck converters, as boost converters or as buck-boost converters.

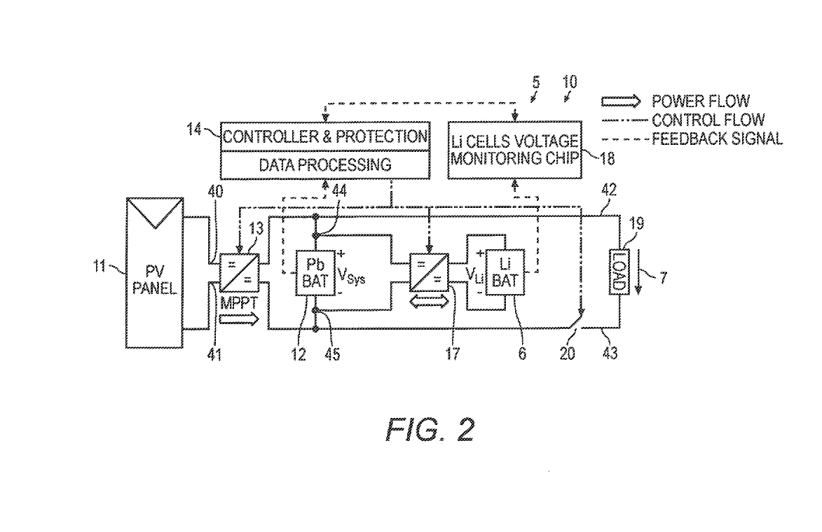

FIG. 2 shows a detailed view of the layout of FIG. 1. According to the layout of FIG. 2, the lithium battery 6 is connected electrically in parallel to the lead-acid battery 12 and to a load 19 via the bidirectional DC/DC converter 17. Furthermore, output lines of the DC/DC converter are connected electrically in parallel to the lead-acid battery 12. A load switch 20 is connected electrically in series to the load 19. The load switch 20 is provided to prevent a deep discharge and it may be implemented as a semiconductor switch such as a bipolar transistor, a FET, an IGBT, or others. An arrow 7 indicates a direction of current.

Dashed arrows in FIG. 2 indicate the flow of sensor signals to the charge control system 14 and to the voltage-monitoring chip 18 while dash-double-dot arrows indicate the flow of signals between the charge control system 14 and the voltage monitoring chip and the flow of control signals from the charge control system 14.

The hybrid storage system provides a positive input terminal 40 and a negative input terminal 41, which are connected to corresponding output terminals of the photovoltaic panel (or other energy sources) 11, and a positive output terminal 42 and a negative output terminal 43, which are connected to corresponding input terminals of the load 19. The lithium subsystem 9 comprises a positive input terminal 44 and a negative input terminal 45, which are connected to respective terminals of the lead acid battery 12. Furthermore, the lithium subsystem 9 comprises a positive output terminal 46 and a negative output terminal 47 which are connected to respective terminals of the lithium battery 6.

For a load 19 that comprises an AC consumer, a DC/AC converter may be connected between the output terminals 42 and 43, and the load 19. A DC/AC converter may be provided, for example by a switched H-bridge or a switched three-phase inverter.

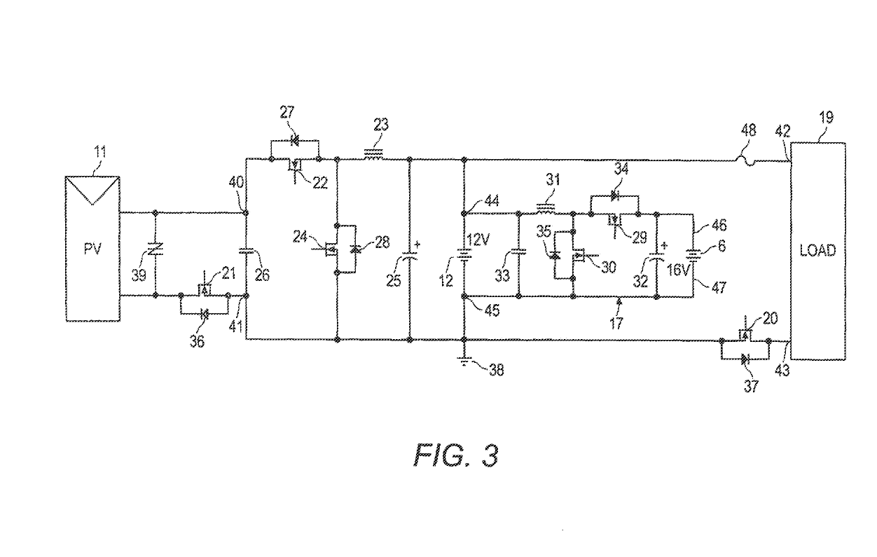

FIG. 3 shows a circuit diagram of the hybrid storage system 5 according to FIG. 2. In the example of FIG. 3, the lead-acid battery 12 can deliver a voltage of around 12 V and the lithium battery 6 can deliver a voltage of around 24 V. The photovoltaic panel 11 is connected to the hybrid storage system 5 via a reverse current protection MOSFET 21 (may also be a diode). A TVS-diode 39 for transient voltage suppression (TVS) and overvoltage suppression is connected electrically in parallel to the photovoltaic panel 11.

The DC/DC converter 13, which is connected to outputs of the photovoltaic panel 11 and to battery terminals of the lead-acid battery 12, comprises a first MOSFET 22, a second MOSFET 24, and inductor 23, which are connected in star connection. A first terminal of a capacitor 25 is connected to a plus pole battery terminal of the lead-acid battery 12 and a second terminal of the capacitor 25 is connected to a minus pole battery terminal of the lead-acid battery 12.

Furthermore, a second capacitor 26 is connected electrically in parallel to the input terminals 40 and 41 and works as an input filter. The first MOSFET 22 comprises a parasitic diode 27 and the second MOSFET 24 comprises a parasitic diode 28.

During operation, the output power of the photovoltaic panel 11 or of the DC/DC converter 13 is measured by the charge control system 14. A control signal of the charge control system 14 adjusts the ratio of the DC/DC converter 13 via opening and closing of the MOSFETS 22 and 24 according to a maximum power point of the photovoltaic panel 11.

The DC/DC converter 17, which is connected to battery terminals of the lithium battery 6 and to battery terminals of the lead-acid battery 12, comprises a first MOSFET 29, a second MOSFET 30 and inductor 31 which are connected in star connection. A plus pole battery terminal of the lithium battery 6 is connected to a first terminal of a capacitor 32 and a minus pole battery terminal of the lithium battery 6 is connected to a second terminal of the capacitor 32.

The capacitors 25, 26, 32 and 33, on the other hand, act as filters for smoothing out the output voltage.

The first MOSFET 29 comprises a parasitic diode 34 and the second MOSFET 30 comprises a parasitic diode 35. The protection MOSFET 21 comprises a parasitic diode 36 and the load switch 20 comprises a parasitic diode 37. The parasitic diodes 27, 28, 34, 35, 36 and 37 also act as freewheel diodes with respect to the corresponding MOSFETS 22, 24, 29, 30, 21, and 20. Instead of MOSFETS, other field effect transistors may be used as well, like for example IGBTs, JFETs or others.

A fuse 38 is provided close to a positive output terminal of the hybrid storage system 5 to protect the circuitry of the hybrid storage system 5 from overload. A ground potential 38 is connected to the minus pole terminal of the lead-acid battery 12, to the minus pole terminal of the lithium battery 6 and to respective terminals of the capacitor 25, the second MOSFET 24 and the second capacitor 26 of the DC/DC converter 13.

According to the present invention, separate switches at the batteries 6, 12 are not required. The lead acid battery 12 and the lithium battery 6 may be equipped with switches, respectively, for connecting and disconnecting the lead acid battery 12 and the lithium battery 6, however.

The DC/DC converter 13 is controlled through control signals at the respective gate electrodes of the MOSFETS 24 and 22 and the DC/DC converter 17 is controlled through control signals at the respective gate electrodes of the MOSFETS 29 and 30. The DC/DC converters 13 and 17 can be operated as charge pulse generators by applying pulse width modulated pulses at the respective bases or gates of the respective transistors.

In a charge mode, the charge pulses can be used for charging the batteries lead-acid battery 12 and the lithium battery 6 and, in a recovery mode, they can be used for desulfurization of the lead acid battery 12. With respect to charging, the term “pulse-width modulation” (PWM) refers to applied signals at semiconductor switches. The generated charge or voltage pulses will in general not take the shape of rectangular pulses. This is different from the output of a switched H-bridge for driving a motor via PWM, for example.

During operation, a voltage of the lithium battery 6 is measured by the voltage monitoring chip 18 and a voltage of the lead-acid battery 12 is measured by the charge control system 14. The charge control system 14 adjusts the current of the DC/DC converter 13 via control signals to the MOSFETS 22 and 24. Similarly, the charge control system 14 adjusts the current or power through the DC/DC converter 17 via control signals to the MOSFETS 29 and 30. By increasing the input voltage through the DC/DC converters 13 and 17, the photovoltaic panel can be used for charging the batteries 12 and 6 even in periods of weaker insolation.

Furthermore, the charge control system 14 controls the opening and closing of the protection MOSFET 21 and of the load switch 20 by respective control signals.

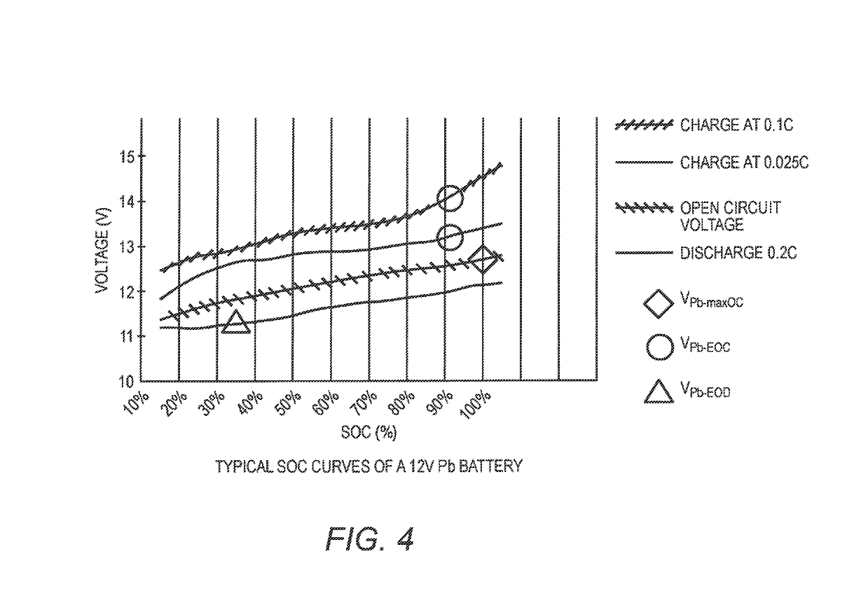

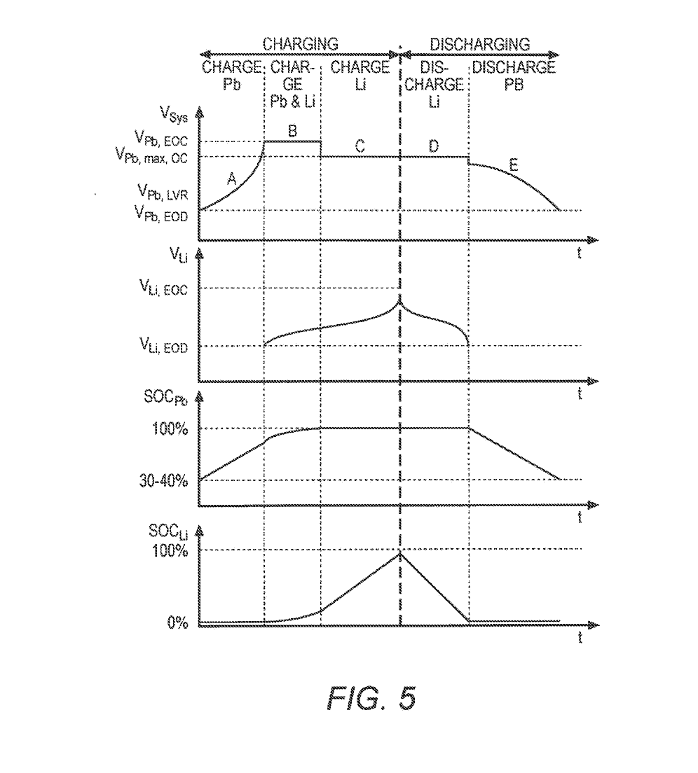

The generation of the control signals of the charge control system 12 according to the present invention is now explained in more detail with respect to the following FIGS. 4 and 5.

FIG. 4 shows state of charge curves for a 12 V lead-acid battery under different conditions. The topmost curve shows an external voltage that is required for charging the lead-acid battery at a charge rate of 0.1C. This charge rate signifies a capacity of a battery in ten hours. At a charge rate of 0.1C, the lead-acid battery reaches an end-of-charge voltage V_EOC of about 13.5V at a state of charge (SOC) of about 90%, which is indicated by a circle symbol. The second curve from the top shows an external voltage that is required for charging the lead-acid battery at a charge rate of 0.025C. In this case, the lead-acid battery reaches an end-of-charge voltage V_EOC of about 13V at a state of charge of about 90%, which is indicated by a circle symbol.

The second curve from below shows open circuit voltages for different charge states of the lead-acid battery. A maximum open circuit voltage V_maxOC of about 12.5 Volt is marked by a diamond symbol. The lowest curve shows a voltage that is delivered by the lead-acid battery when a load is chosen such that the lead-acid battery is discharged at a discharge rate of about 0.2C. At a charge state of about 35% battery charge, an end of discharge voltage is reached. The voltage V_EOD between the battery terminals of the lead-acid battery at the end of discharge, which is at about 11.2 Volt, is marked by a triangle symbol.

In general, the following voltages are used in the control algorithms according to the present invention.
V_Sys, which corresponds to the voltage of the lead acid battery 12 and to the voltage at the second set of terminals of the DC/DC converter 17. According to the application, a decision on which battery is charged or discharged depends on V_sys and, as an option, on the current.
V_EOC, which denotes an end-of-charge voltage. In lithium batteries, this voltage (V_Li_EOC) can correspond to a SOC of about 100%. By contrast, the end-of-charge voltage in lead (Pb) batteries (V_Pb_EOC) corresponds to a SOC of 85-90%. In order to reach an SOC of 100%, the lead acid battery has to be charged further after the end-of-charge voltage has been reached. As shown in FIG. 4, the voltage V_Pb_EOC can depend on the charge rate. Furthermore, it also depends on characteristics of the lead acid battery such as age and operating temperature.
V_EOD, which denotes an end-of-discharge voltage. In lithium batteries, this voltage (V_Li_EOD) corresponds to a certain low level of SOC, whereas in lead batteries, in order to avoid damage to the battery, this voltage (V_Pb_EOD) will correspond to a SOC of e.g. 30-35%, as shown in FIG. 4. The voltage V_Pb_EOD depends also on the discharge current, age of the battery and battery temperature. It does not correspond to a pre-determined fixed value in the control storage algorithm.

In a charging method according to the present invention, a pulse width modulation (PWM) charging mode is used to charge the lead-acid battery 12. The PWM charging mode provides an efficient charging mode for lead-acid batteries. A surplus energy, which is not needed for the PWM charging of the lead-acid battery 12, is automatically transferred to the lithium battery 6 of the lithium subsystem 9. Thereby, a surplus of electric energy from the photovoltaic cells 11 is used to charge the lithium battery 6.

In a discharging method according to the present invention, the lithium subsystem is controlled to maintain a system voltage V_sys at a threshold voltage that corresponds to a voltage of the fully charged lead-acid battery 12. The system voltage V_sys is indicated in FIG. 2 by an arrow and it is measured between the connection lines to the lead-acid battery 12, which are connected to terminals of the lithium subsystem 9.

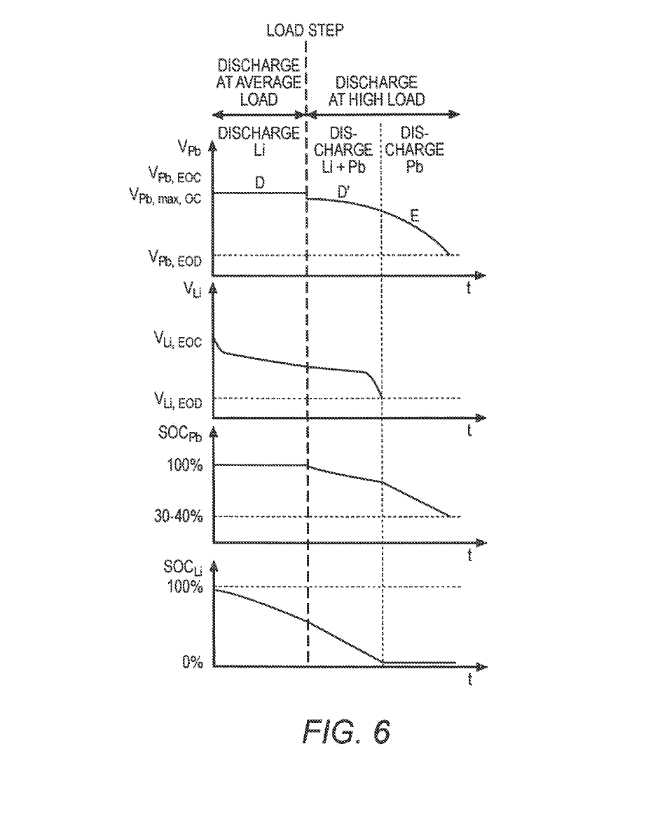

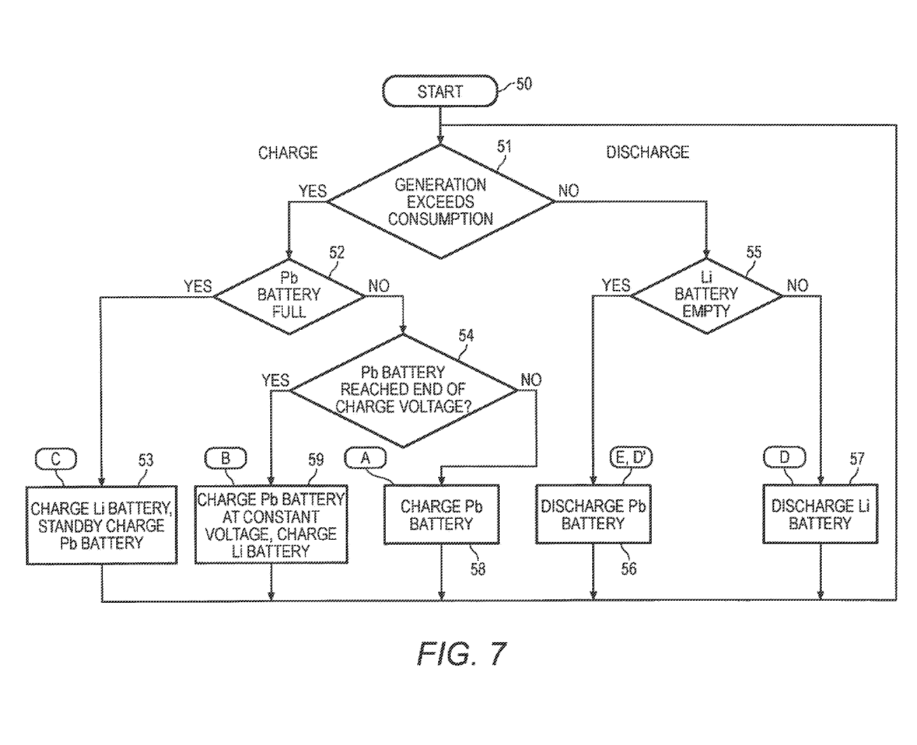

FIG. 5 shows voltage and state of charge diagrams for the lead-acid battery and for the lithium battery during a charging process according to the application. In FIGS. 5 and 6, system states, which are determined by the charge states of the two batteries, is labelled by letters A to E. The letters correspond to labels in the flow diagram of FIG. 7. The letters A-E furthermore denote charge and discharge phases. As shown in FIG. 6, there is an additional discharge phase D-D′ when the load draws more power than the lithium battery 6 can deliver. In this case, the lead-acid battery, which is also connected to the load, will discharge simultaneously as the system voltage falls below the end of charge voltage of the lead-acid battery 12.

During the charging and the discharging process the charge control system 14 estimates the states of charge SOC_Pb and SOC_Li of the batteries 6, 12 based on the time dependence of the system voltage and/or on the current supplied to the batteries 6, 12.

In a first charging phase A, only the lead-acid battery 12 is charged. In the example of FIG. 5, a voltage at the lead-acid battery 12 is at an end-of-discharge voltage V_Pb_EOD and a voltage at the lithium battery 6 is at an end-of-discharge voltage V_Li_EOD.

During the first charging phase, the state of charge of the lead-acid battery 12 increases. The system voltage V_sys at terminals of the lead-acid battery 12 is measured in regular time intervals. As soon as the system voltage V_sys reaches the end-of-charge voltage V_Pb_EOC of the lead-acid battery 12, a second charging phase starts. In the second charging phase B, the lead-acid battery and the lithium battery are both charged. As soon as the state of charge SOC_Pb of the lead-acid battery 12 reaches approximately 100%, a third charging phase C is started, in which the lithium battery 6 is charged with a current and the lead-acid battery 12 is kept at the same SOC with a trickle charge. This can be seen in the state of charge diagrams, which show an increase of the lithium battery's state of charge and a constant state of the charge for the lead-acid battery.

FIG. 5 also shows a discharging process according to the application for a situation in which both batteries 6, 12 are fully charged at the beginning of the discharging process. In a first discharging phase D, only the lithium battery 6 is discharged. In the example of FIG. 5, the discharge current from the lithium battery 6 is approximately constant. As soon as the state of charge of the lithium battery 6 reaches a lower bound, only the lead-acid battery is discharged in a second discharge phase E.

In the example of FIG. 5, the time when the lower bound of SOC_Li is reached, is determined by the moment in which the voltage at the lithium battery drops to an end-of-charge voltage V_Li_EOC. The charge control system 14 disconnects the lead-acid battery 12 from the load by opening the load switch 12 when the system voltage V_sys reaches an end-of-discharge voltage V_Pb_EOD.

FIG. 6 shows a second discharging process, wherein, in a discharge phase D′, the load draws more current than the lithium battery is able to deliver. In this case, the system voltage V_sys at the terminals of the lead acid battery 12 drops below the maximum open circuit voltage V_PB_max OC of the lead-acid battery, as shown in the topmost diagram of FIG. 6, and the lead-acid battery 12 is discharged together with the lithium battery 6. The discharge phases D′ and E are similar to those described with reference to FIG. 5.

FIG. 7 shows a flow diagram of the discharging and the charging process, which indicates the operation principle of the charge control system 14.

In a step 50, a charge/discharge control is activated, for example by plugging in the lead-acid battery 12 and the lithium battery 6. This may involve additional steps, such as checking the health of the batteries and the correct connection of the batteries. In a decision step 51, it is decided whether enough power is available to charge the batteries. In a decision step 52, it is decided if the lead-acid battery 12 is fully charged, for example by measuring the system voltage V_sys. If the lead-acid battery 12 is determined as fully charged, the lithium battery 6 is charged and the lead-acid battery 12 is provided with a trickle charge in a step 53. If it is determined in step 52 that the lead-acid battery 12 is not yet fully charged, it is decided, in a decision step 54, if the lead-acid battery 12 has reached an end-of-charge voltage.

If the lead-acid battery 12 has not yet reached the end-of-charge voltage, it is charged in a step 58. If, on the other hand, it is determined that the lead-acid battery has reached the end-of-charge voltage, the lead acid battery 12 is charged at a constant voltage while the lithium battery 6 is charged simultaneously.

If, in the decision step 51, it is determined that the generation does not exceed the consumption and the consumption is greater zero, than it is determined, in a decision step 55, if the lithium battery 6 is empty, wherein “empty” corresponds to a low SOC. If it is determined that the lithium battery 6 is empty, the lead-acid battery 12 is discharged in a step 56 while the state of charge SOC_Pb of the lead-acid battery 12 exceeds a lower bound of 30-40%, for example. If, on the other hand, it is determined in step 55, that the lithium battery 6 is not empty, the lithium battery 6 is discharged in a step 57. If, during execution of step 56, a load draws more current than the lithium battery 6 can supply, a voltage at terminals of the lead-acid battery 12 drops below the end-of-charge voltage V_EOC_Pb and the lead-acid battery 12 will also be discharged.

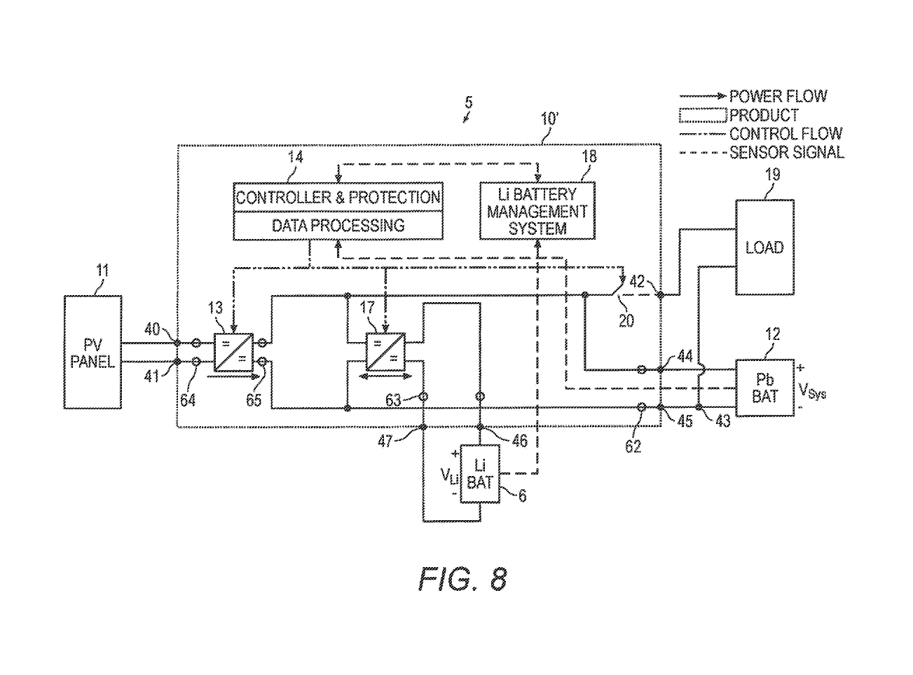

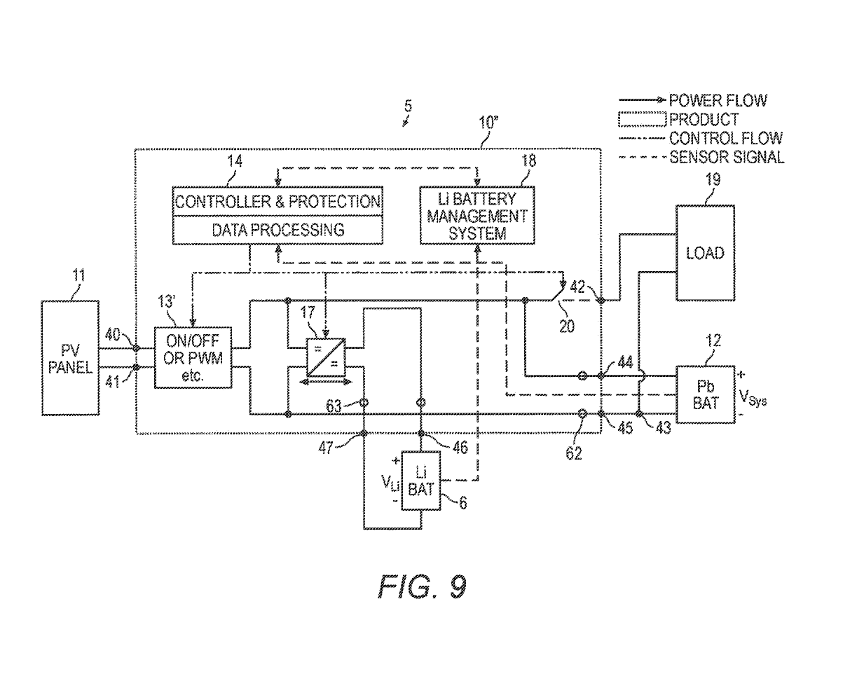

FIGS. 8 and 9 show further embodiments of a hybrid storage system 5, which are similar to the embodiment of FIGS. 1 to 3. According to the embodiments of FIGS. 8 and 9, the batteries 6 and 12 do not form part of the hybrid storage system 5 but are plugged into the hybrid storage system 5.

According to one embodiment of FIG. 8, the batteries 6, 12 are provided with voltage sensors and with connections for connecting the voltage sensors to the hybrid storage system 10′. The hybrid storage system 10′ is provided with a lead acid battery voltage sensor 62 and a lithium battery voltage sensor 63. Furthermore, an input voltage sensor 64 and a supply current sensor 65 may be provided. The sensors, which are symbolized by open circles in FIG. 8, can be realized in various ways. For example, the sensors may be connected to two corresponding electric lines or to only one electric line. The current sensor may also be provided as magnetic field sensor.

The embodiment of FIG. 9 is similar to the embodiment of FIG. 8 but, in contrast to the preceding embodiment, the hybrid storage system 10″ comprises only one DC/DC converter 17, which is provided for an adjustment of a voltage at terminals of the lithium battery 6. Instead of the second DC/DC converter 13, and input current adjustment means 13′ is provided, for example a controllable On/Off switch, a controllable pulse width modulation (PWM), an overvoltage protection or others. The current adjustment means may be connected to the charge control system 14 by a control line, as shown in FIG. 9.

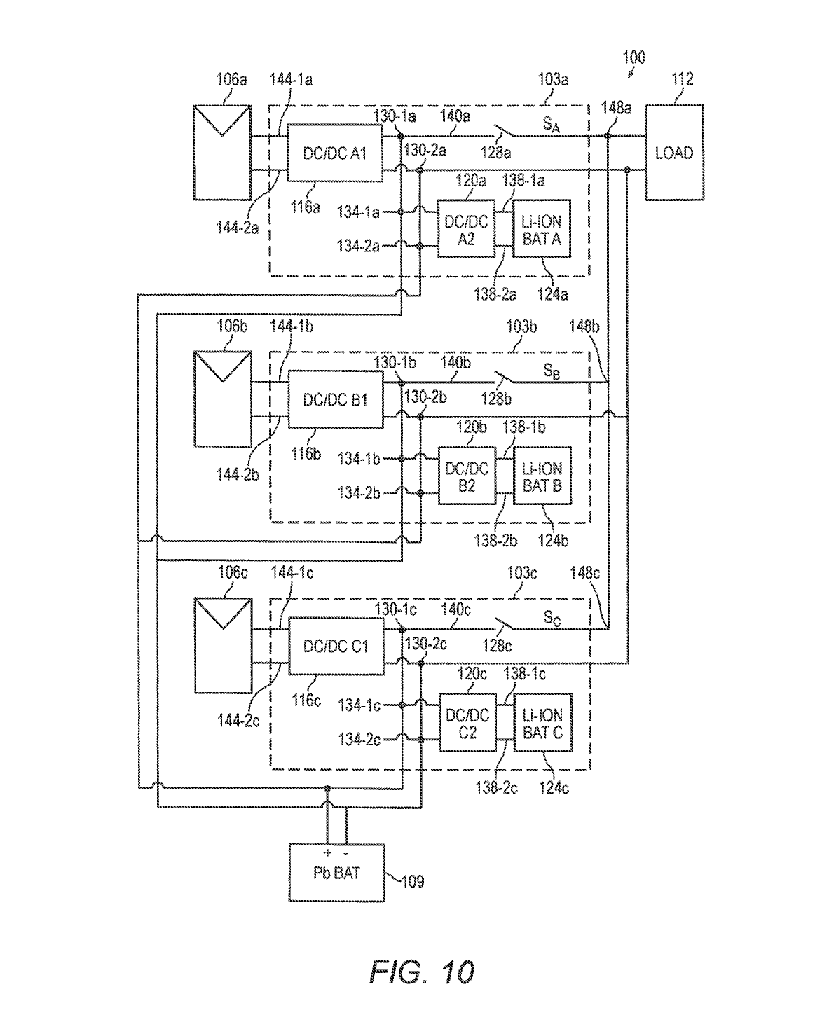

FIG. 10 shows an energy storage device 100. The energy storage device 100 comprises a plurality of hybrid storage systems 103a, 103b, and 103c, a plurality of photovoltaic panels 106a, 106b, and 106c, a lead acid battery 109, and an electrical resistive load 112.

The hybrid storage systems 103a, 103b, and 103c are connected electrically in parallel to each other. The hybrid storage systems 103a, 103b, and 103c are also connected to the corresponding photovoltaic panels 106a, 106b, and 106c. The hybrid storage systems 103a, 103b, and 103c are also connected to one lead acid battery 109 and one resistive load 112.

In particular, each hybrid storage system 103a, 103b, and 103c includes a corresponding one-way DC/DC converter 116a, 116b, and 116c, a corresponding two-way DC/DC converter 120a, 120b, and 120c, a corresponding lithium battery 124a, 124b, and 124c, and a corresponding load switch 128a, 128b, and 128c. The DC/DC converter is also called a DC-to-DC converter.

A pair of output terminals 130-1a and 130-2a of the one-way DC/DC converter 116a is connected to a pair of first terminals 134-1a and 134-2a of the two-way DC/DC converter 120a. A pair of second terminals 138-1a and 138-2a of the two-way DC/DC converter 120a is connected to a positive terminal and a negative terminal of the lithium battery 124a respectively. One output terminal 130-1a of the one-way DC/DC converter 116a is also connected to a first terminal 140a of the load switch 128a.

A pair of input terminals 144-1a and 144-2a of the one-way DC/DC converter 116a is connected to the photovoltaic panel 106a. A second terminal 148a of the load switch 128a and the output terminal 130-2a of the one-way DC/DC converter 116a are connected to the resistive load 112. The output terminals 130-1a and 130-2a of the one-way DC/DC converter 116a are connected to a positive terminal and a negative terminal of the lead acid battery 109 respectively.

Similarly, a pair of output terminals 130-1b and 130-2b of the one-way DC/DC converter 116b is connected to a pair of first terminals 134-1b and 134-2b of the two-way DC/DC converter 120b. A pair of second terminals 138-1b and 138-2b of the two-way DC/DC converter 120b is connected to a positive terminal and a negative terminal the lithium battery 124b respectively. One output terminal 130-1b of the one-way DC/DC converter 116b is also connected to a first terminal 140b of the load switch 128b.

A pair of input terminals 144-1b and 144-2b of the one-way DC/DC converter 116b is connected to the photovoltaic panel 106b. A second terminal 148b of the load switch 128b and the output terminal 130-2b of the one-way DC/DC converter 116b are connected to the resistive load 112. The output terminals 130-1b and 130-2b of the one-way DC/DC converter 116b are connected to the positive terminal and the negative terminal of the lead acid battery 109 respectively.

Likewise, a pair of output terminals 130-1c and 130-2c of the one-way DC/DC converter 116c is connected to a pair of first terminals 134-1c and 134-2c of the two-way DC/DC converter 120c. A pair of second terminals 138-1c and 138-2c of the two-way DC/DC converter 120c is connected to a positive terminal and a negative terminal of the lithium battery 124c respectively. One output terminal 130-1c of the one-way DC/DC converter 116c is also connected to a first terminal 140c of the load switch 128c.

A pair of input terminals 144-1c and 144-2c of the one-way DC/DC converter 116c is connected to the photovoltaic panel 106c. A second terminal 148c of the load switch 128c and the output terminal 130-2c of the one-way DC/DC converter 116c are connected to the resistive load 112. The output terminals 130-1c and 130-2c of the one-way DC/DC converter 116c are connected to the positive terminal and the negative terminal of the lead acid battery 109 respectively.

Furthermore, the second terminal 148a of the load switch 128a is connected to the second terminal 148b of the load switch 128b and to the second terminal 148c of the load switch 128c.

The output terminal 130-2a of the one-way DC/DC converter 116a is connected to the output terminal 130-2b of the oneway DC/DC converter 116b and to the output terminal 130-2c of the one-way DC/DC converter 116c.

An additional communication between the hybrid storage systems 103a, 103b, and 103c is not mandatory. However, the said communication can enable further functionalities, for example, electrical current compensation during electrical charge discharging by summing up measured discharge electrical currents in all hybrid storage systems 103a, 103b, and 103c.

The said communication can also increase measurement accuracy, such as calculating the average value, rather than instantaneous value, of measured lead acid battery voltage. This aligns the two-way DC/DC converter operation states.

In summary, the hybrid storage systems 103a, 103b, and 103c are connected electrically in parallel to one common lead acid battery 109. The load 112 is indirectly connected to the lead acid battery 109 via the hybrid storage systems 103a, 103b, and 103c.

The energy storage device 100 provides an advantage of a “deep discharge protection” of the lead acid battery 109. The said protection is achieved by the load switches 128a, 128b, and 128c being open when the lead acid battery voltage is too low.

The energy storage device 100 also provides a benefit of allowing increase of the lithium power and of lithium storage capacity by simply adding further hybrid storage systems.

The photovoltaic panels 106a, 106b, and 106c are not connected in series. The series connection would increase its output voltage, thereby making the photovoltaic panels 106a, 106b, and 106c more difficult to handle during installation and maintenance.

The energy storage device 100 has only one lead-acid battery 109. This avoids unbalanced current distribution, which can occur in an arrangement of several lead-acid batteries. The unbalanced current distribution can require expensive circuit and switch design circuit for managing the current distribution.

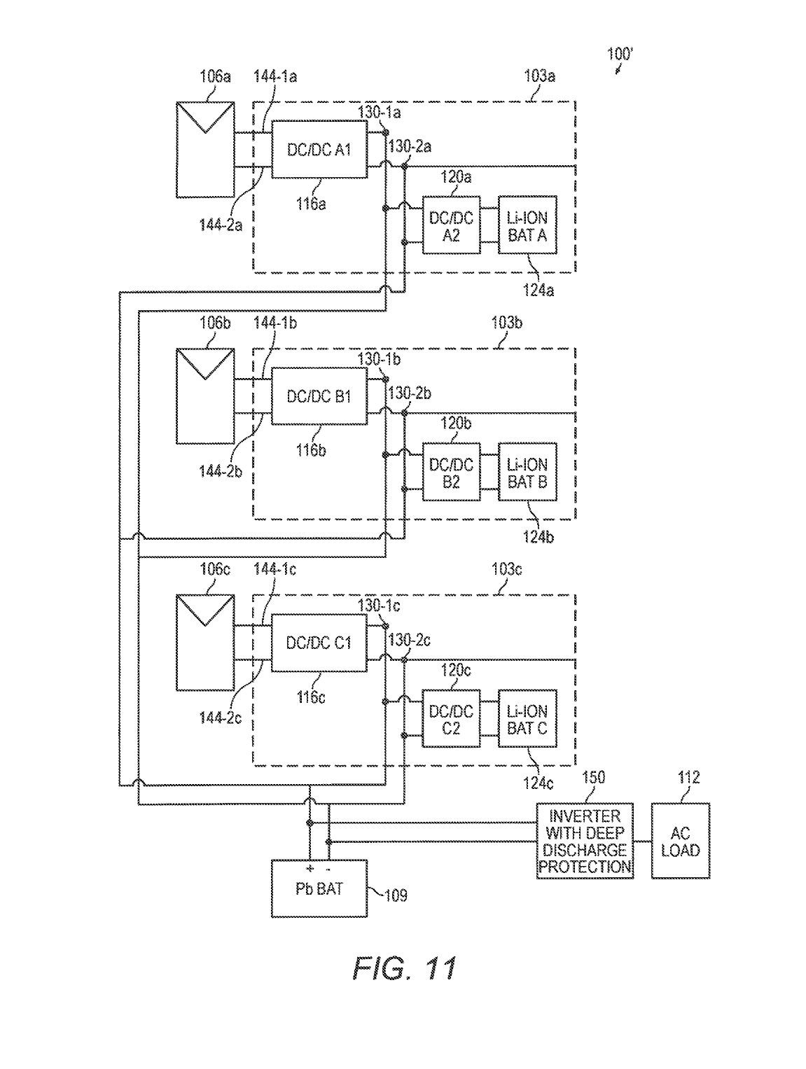

FIG. 11 shows a variant of the energy storage device 100 of FIG. 10. FIG. 11 shows another arrangement of three hybrid storage systems, wherein its load is connected to its lead acid battery.

FIG. 11 shows an energy storage device 100′. The energy storage device 100′ comprises a plurality of hybrid storage systems 103a, 103b, and 103c, a lead acid battery 109, a load 112 as well as an inverter 150 with a deep discharge protection. The deep discharge protection is realized within the connected load 112.

A pair of input terminals 144-1a and 144-2a of the one-way DC/DC converter 116a of the hybrid storage system 103a is connected to the photovoltaic panel 106a.

Output terminals 130-1a and 130-2a of a one-way DC/DC converter 116a of the hybrid storage system 103a are connected to a positive terminal and a negative terminal of the lead acid battery 109 respectively.

Similarly, a pair of input terminals 144-1b and 144-2b of the one-way DC/DC converter 116b of the hybrid storage system 103b is connected to the photovoltaic panel 106b.

Output terminals 130-1b and 130-2b of a one-way DC/DC converter 116b of the hybrid storage system 103b are connected to the positive terminal and the negative terminal of the lead acid battery 109 respectively.

Likewise, a pair of input terminals 144-1c and 144-2c of the one-way DC/DC converter 116c of the hybrid storage system 103c is connected to the photovoltaic panel 106c.

Output terminals 130-1c and 130-2c of a one-way DC/DC converter 116c of the hybrid storage system 103c are connected to the positive terminal and the negative terminal of the lead acid battery 109 respectively.

The positive terminal and the negative terminal of the lead acid battery 109 are also connected to the inverter 150 with a deep discharge protection, which is connected to the load 112.

In general, the load 112 can include the deep discharge protection, but not including necessarily an inverter.

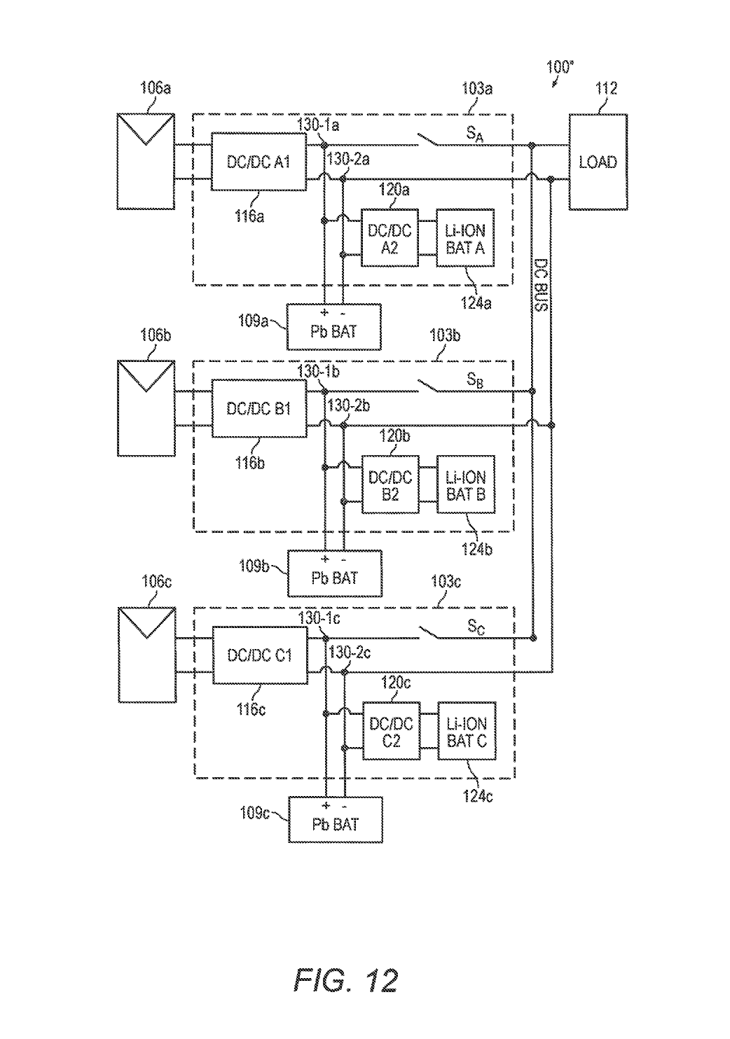

FIG. 12 shows a further variant of the energy storage device 100 of FIG. 10. FIG. 12 shows three hybrid storage systems connected electrically in parallel to a resistive load while each hybrid storage system is connected to a separate lead acid battery.

FIG. 12 shows an energy storage device 100″. The energy storage device 100″ and the energy storage device 100 have similar parts.

The energy storage device 100″ comprises a plurality of hybrid storage systems 103a, 103b, and 103c, a plurality of lead acid batteries 109a, 109b, and 109c, and a load 112.

Output terminals 130-1a and 130-2a of a one-way DC/DC converter 116a of the hybrid storage system 103a are connected to a positive terminal and to a negative terminal of a first lead acid battery 109a respectively.

Similarly, output terminals 130-1b and 130-2b of a one-way DC/DC converter 116b of the hybrid storage system 103b are connected to a positive terminal and a negative terminal of a second lead acid battery 109b respectively.

Output terminals 130-1c and 130-2c of a one-way DC/DC converter 116c of the hybrid storage system 103c are connected to a positive terminal and a negative terminal of a third lead acid battery 109c respectively.

The energy storage device 100″ has an advantage of enabling easy increase of electrical storage power and of storage ratings just by adding more hybrid storage systems.

The energy storage device 100″ also provides redundant lead acid battery storage in a case of lead acid battery malfunction or break down.

The energy storage device 100″ also has a benefit of allowing the ratio of lithium battery to lead acid battery to remain unchanged when additional hybrid storage systems are added.

The energy storage device 100″ has several smaller lead acid batteries 109a, 109b, and 109c, instead of one large lead acid battery. After long term of use, when the smaller lead acid battery 109a, 109b, or 109c becomes faulty, only the faulty lead-acid battery needs to be replaced, rather than replacing the entire one large battery.

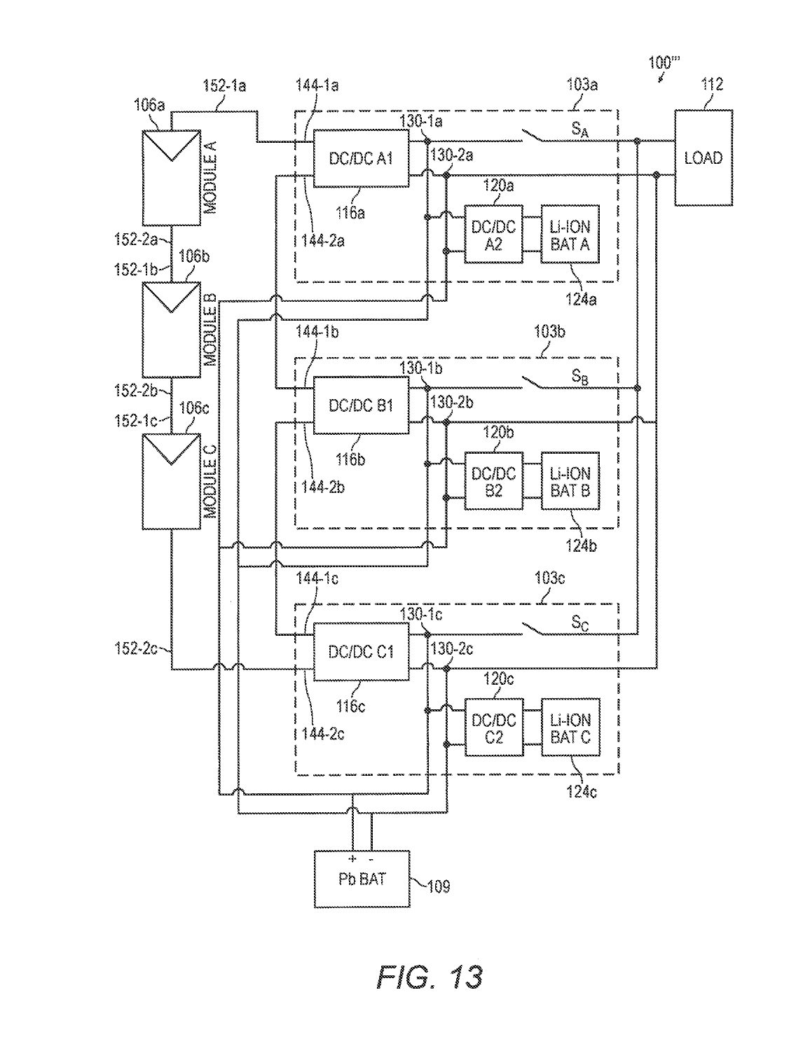

FIG. 13 shows another variant of the energy storage device 100 of FIG. 10, wherein its photovoltaic panels are connected electrically in series.

FIG. 13 shows an energy storage device 100′″. The energy storage device 100′″ comprises a plurality of hybrid storage systems 103a, 103b, and 103c, a plurality of photovoltaic panels 106a, 106b, and 106c, a lead acid battery 109, and an electrical resistive load 112.

The photovoltaic panels 106a, 106b, and 106c are connected electrically in series. A first terminal 152-1a of the photovoltaic panel 106a is connected to an input terminal 144-1a of a one-way DC/DC converter 116a of the hybrid storage system 103a. A second terminal 152-2a of the photovoltaic panel 106a is connected to a first terminal 152-1b of the photovoltaic panel 106b. A second terminal 152-2b of the photovoltaic panel 106b is connected to a first terminal 152-1c of the photovoltaic panel 106c. A second terminal 152-2c of the photovoltaic panel 106c is connected to a second input terminal 144-2c of a one-way DC/DC converter 116c of the hybrid storage system 103c.

The hybrid storage systems 103a, 103b, and 103c are connected to one lead acid battery 109 and one resistive load 112.

This energy storage device 100′″ has an advantage of reducing electrical cables for connecting the photovoltaic panels 106a, 106b, and 106c. The photovoltaic panels 106a, 106b, and 106c are normally installed on a rooftop while the hybrid storage systems 103a, 103b, and 103c are normally installed on ground level. This arrangement of the energy storage device 100′″ requires two wires, instead of six wires, for connecting the photovoltaic panels 106a, 106b, and 106c to the hybrid storage systems 103a, 103b, and 103c.

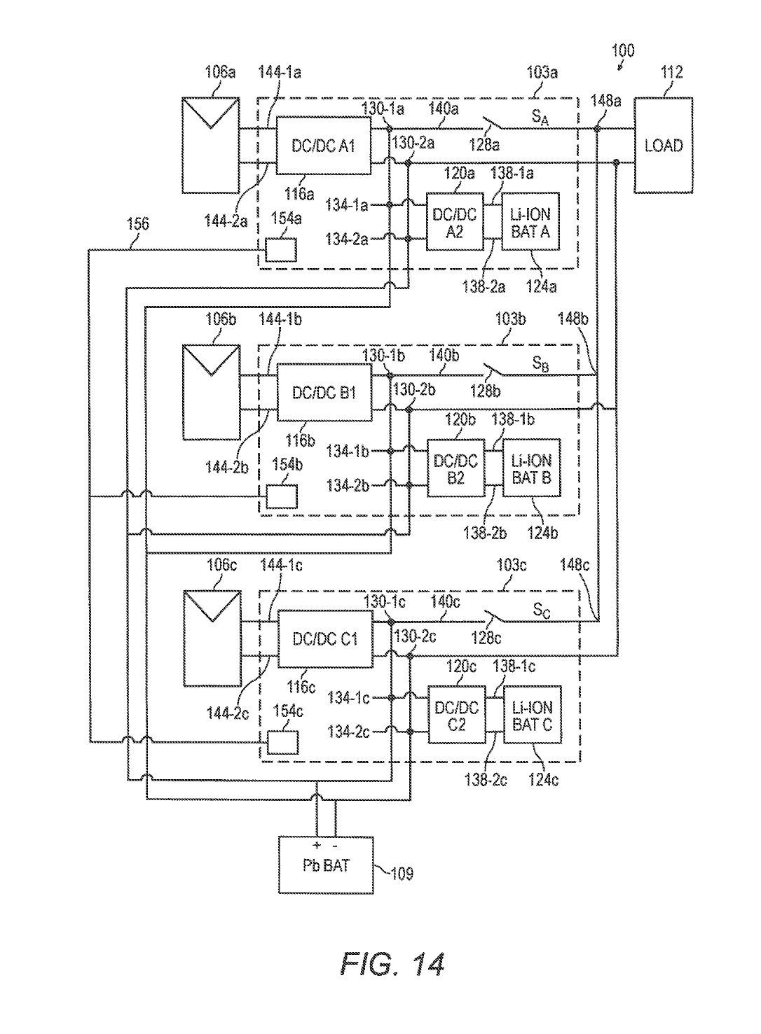

FIG. 14 shows the energy storage device 100 of FIG. 10 with master and slave controllers.

The energy storage device 100 comprises a hybrid storage system 103a, a hybrid storage system 103b, and a hybrid storage system 103c.

The hybrid storage system 103a includes a master controller 154a. The hybrid storage system 103b includes a first slave controller 154b while the hybrid storage system 103c includes a second slave controller 154c.

The master controller 154a is connected to the first slave controller 154b and to the second slave controller 154c via a control line 156.

In use, the master controller 154a, the first slave controller 154b, and the second slave controller 154c manage respectively states of charge of the lithium batteries 124a, 124b, and 124c.

The master controller 154a sends control signals to the first slave controller 154b, and to the second slave controller 154c via the control line 156 for synchronizing the management of the charge states of the lithium batteries 124a, 124b, and 124c.

In effect, the control line 156 allows the master controller 154a to send commands or control signals to the first slave controller 154b and the second slave controller 154c.

The first slave controller 154b and the second slave controller 154c follow the master controller 154a with respect to charging and discharging of the lithium batteries 124a, 124b, and 124c.

The charging step and the discharging step can be separated by a time delay for avoiding or preventing oscillation of the charging or discharging electrical current and voltage.

In detail, the master controller 154a measures a state of charge of the lead-acid battery 109. The master controller 154a then acts to activate or to disable the two-way DC/DC converter 120a for managing a state of charge of the lithium battery 124a according to the measured state of charge of the lead-acid battery 109.

The master controller 154a also transmits the control signals to the first slave controller 154b and to the second slave controller 154c.

The first slave controller 154b receives the control signal from the master controller 154a. The first slave controller 154b then acts to activate or to disable the two-way DC/DC converter 120b for managing a state of charge of the lithium battery 124b according to the control signal.

Similarly, the second slave controller 154c receives the control signal from the master controller 154a. The second slave controller 154c then serves to activate or to disable the two-way DC/DC converter 120c for managing a state of charge of the lithium battery 124c according to the control signal.

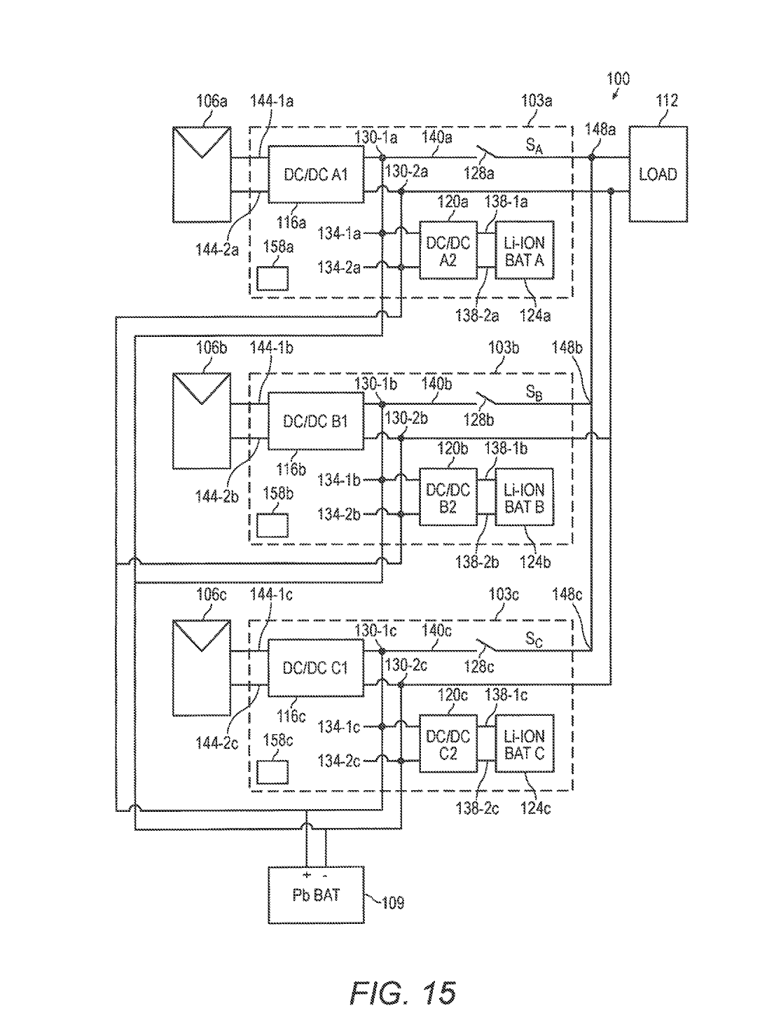

FIG. 15 shows the energy storage device 100 of FIG. 10 with individual controllers.

The energy storage device 100 comprises a hybrid storage system 103a, a hybrid storage system 103b, and a hybrid storage system 103c. The hybrid storage system 103a includes a first controller 158a. The hybrid storage system 103b includes a second controller 158b while the hybrid storage system 103c includes a third controller 158c.

In use, the first controller 158a, the second controller 158b, and the third controller 158c manage respectively states of charge of the lithium batteries 124a, 124b, and 124c.

The controllers 158a, 158b, and 158c together measure a state of charge of the lead-acid battery 109. The controllers 158a, 158b, and 158c then serve to activate or to disable the two-way DC/DC converters 120a, 120b, and 120c respectively for managing states of charge of the lithium battery 124a, 124b, and 124c according to the measured state of charge of the lead-acid battery 109.

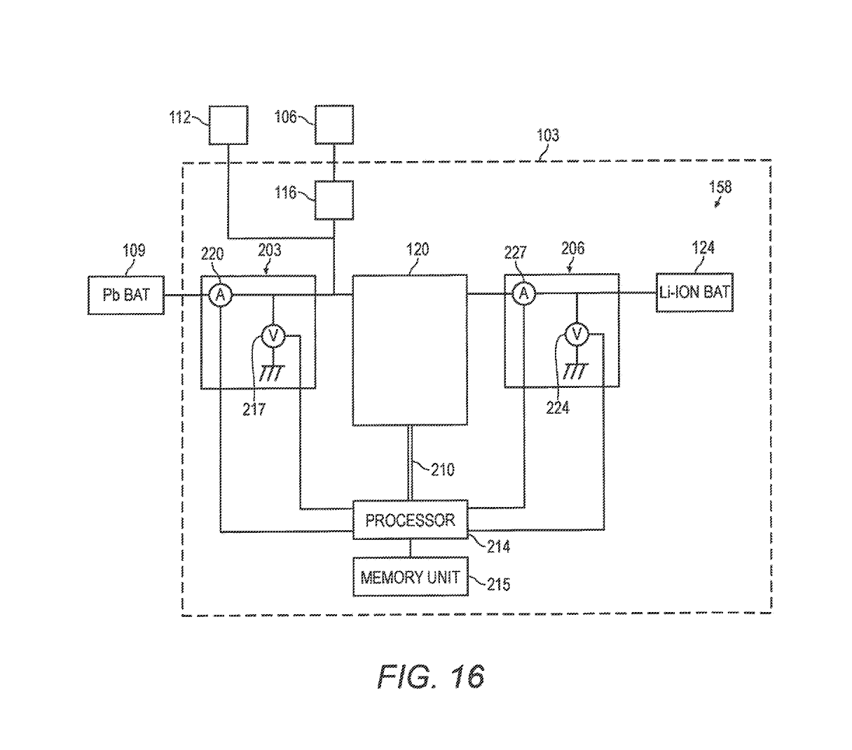

FIG. 16 shows an embodiment of the individual controllers 158a, 158b, and 158c of FIG. 15.

FIG. 16 depicts a current controller 158. The current controller 158 includes a lead-acid battery measurement device 203, a lithium battery measurement device 206, a DC-to-DC converter control bus 210, and a processor 214 with a memory unit 215.

The processor 214 is connected to the lead-acid battery measurement device 203, to the lithium battery measurement device 206, and to the DC-to-DC converter control bus 210.

The lead-acid battery measurement device 203 comprises a lead-acid battery voltmeter 217 and a lead-acid battery ammeter 220. Similarly, the lithium battery measurement device 206 comprises a lithium battery voltmeter 224 and a lithium battery ammeter 227.

The memory unit 215 that stores a pre-determined lead-acid battery voltage value and a pre-determined lithium battery voltage value.

In use, the lead-acid battery measurement device 203 is connected to a lead-acid battery 109. The lead-acid battery voltmeter 217 acts to measure a voltage of the lead-acid battery 109 while the lead-acid battery ammeter 220 serves to measure an electrical current of the lead-acid battery 109.

Similarly, the lithium battery measurement device 206 is connected to a lithium battery 124. The lithium battery voltmeter 224 acts to measure a voltage of the lithium battery 124 while the lithium battery ammeter 227 serves to measure an electrical current of the lithium battery 124.

The DC-to-DC converter control bus 210 is connected to a two-way DC-to-DC converter 120 with an adjustable voltage conversion ratio.

The two-way DC-to-DC converter 120 converts a source of direct current (DC) from a first voltage level to a second voltage level, wherein the converted second voltage level has an adjustable voltage conversion ratio with respect to the first voltage level. This ratio is adjusted or is controlled by the processor 214.

In one implementation, the DC-to-DC converter control bus 210 is connected to MOSFETS 29 and 30 of a charge control system 14 of FIG. 3 for adjusting an electrical current or electrical power from the two-way DC-to-DC converter 120 to the lithium battery 124.

The processor 214 acts to obtain the lead-acid battery voltage measurement from the lead-acid battery voltmeter 217 and to obtain the lead-acid battery electrical current measurement from the lead-acid battery ammeter 220.

The processor 214 also serves to obtain the lithium battery voltage measurement from the lithium battery voltmeter 224 and to obtain the lithium battery electrical current measurement from the lead-acid battery ammeter 220.

The processor 214 also acts to obtain the pre-determined lead-acid battery voltage value and the pre-determined lithium battery voltage value from the memory unit 215.

The processor 214 is adapted to produce a set-up voltage value from the lead-acid battery voltage measurement, from the lead-acid battery electrical current measurement, from the lithium battery voltage measurement, and from the lithium battery electrical current measurement, as well as from the pre-determined lead-acid battery voltage value and from the pre-determined lithium battery voltage value.

The processor 214 later generates a control signal according to the set-up voltage value and afterward sends the control signal to the two-way DC-to-DC converter 120 by the DC-to-DC converter control bus 210. The control signal acts to adjust a magnitude and duration of an output electrical current of the two-way DC-to-DC converter 120. In a charging mode, the output electrical current acts to charge the lithium battery 124.

In effect, the adjustment of the voltage conversion ratio serves to adjust the charging or discharging of the lead-acid battery 109 and to adjust the charging or discharging of the lithium battery 124.

In a general sense, the voltage conversion ratio can refer to a voltage step-down conversion ratio or to a voltage step-up conversion ratio.

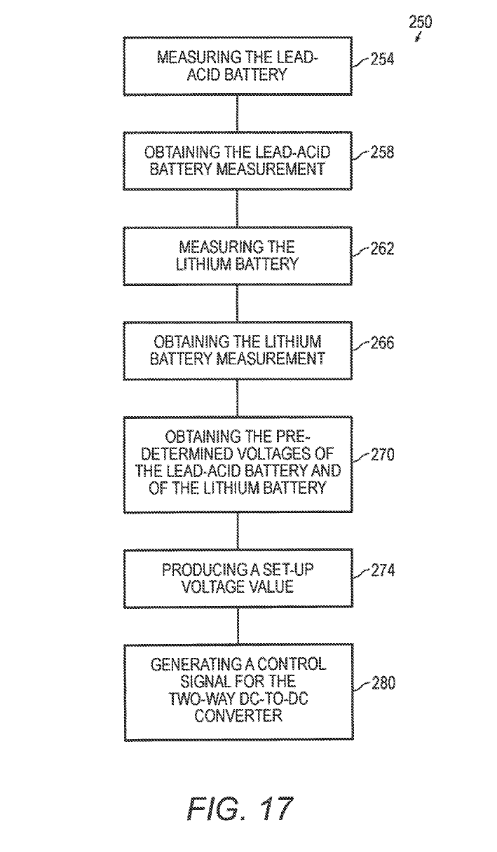

FIG. 17 shows a flow chart 250 of a method of operating the energy storage device 100 of FIG. 15, wherein the energy storage device 100 comprises several hybrid storage systems 103. Each hybrid storage system 103 includes a controller 158.

The method includes a step 254 of multiple lead-acid battery voltmeters 217 of the controllers 158 individually measuring voltages of their corresponding lead-acid batteries 109 and multiple lead-acid battery ammeters 220 of the controllers 158 individually measuring electrical currents of their corresponding lead-acid batteries 109.

Processors 214 of the controllers 158 later individually obtain the lithium battery voltage measurements from their lithium battery voltmeters 224 and individually obtain the lithium battery electrical current measurements from their lead-acid battery ammeters 220, in a step 258.

Multiple lithium battery voltmeters 224 of the controllers 158 then individually measure voltages of their lithium batteries 124. Multiple lithium battery ammeters 227 of the controllers 158 also individually measure electrical currents of their lithium batteries 124, in a step 262.

The processors 214 later individually obtain the lead-acid battery voltage measurements from their lead-acid battery voltmeters 217 and individually obtain the lead-acid battery electrical current measurements from their lead-acid battery ammeters 220, in a step 266.

The processors 214 also individually obtain a pre-determined lead-acid battery voltage value and a pre-determined lithium battery voltage value from their memory units 215, in a step 270.

The processors 214 afterward individually produce set-up voltage values, in a step 274. Each set-up voltage value is produced according to its obtained lead-acid battery voltage measurement, to its obtained lead-acid battery electrical current measurement, to its obtained lithium battery voltage measurement, and to its obtained lithium battery electrical current measurement. The set-up voltage value is also produced according to the pre-determined lead-acid battery voltage value and to the pre-determined lithium battery voltage value.

The processors 214 later individually generate control signals according to their corresponding set-up voltage values and afterward send the control signal to their corresponding two-way DC-to-DC converters 120 by their corresponding DC-to-DC converter control buses 210 for adjusting magnitudes and durations of multiple electrical currents of the two-way DC-to-DC converter 120, in a step 280.

In this manner, the controllers 158 act independently for controlling the charging and discharging of the lithium battery 124 and of the lead-acid battery 109.

In summary, the embodiments of the method can also be described with the following lists of features or elements being organized into an item list.

The respective combinations of features, which are disclosed in the item list, are regarded as independent subject matter, respectively, that can also be combined with other features of the present invention.
1. Hybrid battery charging device comprising
   input terminals for connecting a photovoltaic panel,
   first battery connections for connecting a lead-acid battery,
   second battery connections for connecting a high-cycle chemical battery,
   a two-way DC/DC converter, wherein a first set of terminals of the two-way DC/DC converter is connected with the second battery connections, and wherein a second set of terminals of the two-way DC/DC converter is connected with the first battery connections,
   a charge and discharge control system, which is connected to the DC/DC converter via respective control lines,
   output terminals for connecting a load, wherein an input to the output terminals is derived from the first battery connections.
2. Hybrid battery charging device, further comprising
   a control device which is connected to the charge and discharge control system, wherein input terminals of the control device are connected to the input terminals, and wherein output terminals of the control device are connected to input terminals of the DC/DC converter.
3. Hybrid battery charging device according to item 2, wherein the control device comprises a pulse width modulation.
4. Hybrid battery charging device according to item 2 or item 3, wherein the control device comprises a maximum power point tracker.
5. Hybrid battery charging device according to item 2 or item 3, wherein the control device comprises a controllable switch.
6. Hybrid battery charging device according to item 2 or item 3, wherein the control device comprises a DC/DC converter.
7. Hybrid battery charging device according to one of the preceding items, wherein the two-way DC/DC converter comprises a buck-boost converter, a buck converter, a boost converter or another converter topology.
8. Hybrid battery charging device according to one of the preceding items, wherein the two-way DC/DC converter comprises at least two semiconductor switches, wherein respective input connections of the transistors are connected to the charge control system via respective control lines.
9. Hybrid battery charging device according to one of the preceding items, comprising
   first voltage measuring connections for connecting a first voltage sensor, the first voltage sensor being connected to terminals of the lead-acid battery and the first voltage measuring connections being connected to the charge and discharge control system,
   second voltage measuring connections for connecting a second voltage sensor, the second voltage sensor being connected to terminals of the high-cycle chemical battery and the second voltage measuring connections being connected to the charge and discharge control system.
10. Hybrid battery charging device according to item 1 or item 2, comprising a separate battery management system for the high-cycle chemical battery, the separate battery management system being connected to the charge and discharge control system.
11. Hybrid storage system with a hybrid charging device according to one of the preceding items, further comprising a high-cycle chemical battery which is connected to the second battery connections.
12. Hybrid storage system according to item 11, wherein the high-cycle chemical batter comprises a lithium battery.
13. Hybrid storage system according to item 11, further comprising a capacitor which is connected in parallel to the high-cycle chemical battery.
14. Hybrid storage system according to one of the items 11 to 13, further comprising a lead-acid battery, the lead acid battery being connected to the first battery connections.
15. Hybrid storage system according to one of the items 11 to 14, further comprising a
   a first voltage sensor which is connected to a terminal of the first battery and to the charge and discharge control system,
   a second voltage sensor which is connected to a terminal of the second voltage battery and to the charge and discharge control system.
16. Method for charging a lead-acid battery and a high-cycle chemical battery of a hybrid storage system by an electric power source,
   charging the lead-acid battery in a first battery charging phase until the lead-acid battery has reached a first pre-determined state of charge,
   charging the lead-acid battery and the high-cycle chemical battery in a topping/boost/equalization phase until the lead-acid battery has reached a second predetermined state of charge,
   charging the high-cycle chemical battery in a third battery charging phase during which an essentially constant system voltage is applied to system terminals of the lead-acid battery and the system voltage is converted, especially up-converted, into a charging voltage at terminals of the high-cycle chemical battery.
17. Method according to item 16, the equalization phase further comprising applying a voltage at the lead-acid battery that oscillates between a pre-determined lower voltage and a predetermined upper voltage.
18. Method for charging a hybrid storage system according to item 16 or item 17, further comprising maintaining a mean voltage at terminals of the lead-acid battery at an end-of-charge voltage of the lead-acid battery during the equalization phase.
19. Method for charging a hybrid storage system according to one of items 16 to 18, wherein, during the equalization phase, a system voltage at terminals of the lead acid battery is controlled to be constant such that a charge current to the lead-acid battery decreases and a remaining charging power is transferred to the high-cycle chemical battery.
20. Method for charging a hybrid storage system according to one of items 16 to 19, wherein the essentially constant system voltage that is applied to the system terminals during the charging of the high-cycle chemical battery in the third battery charging phase is equal to a maximum open circuit voltage V_Pb_maxOC of the lead-acid battery.
21. Method for charging a hybrid storage system according to one of items 16 to 20, wherein a decision for starting the equalization phase and a decision for starting the third battery charging phase is taken depending on a system voltage at terminals of the lead-acid battery.
22. Method for discharging a lead-acid battery and a high-cycle chemical battery of a hybrid storage system the method comprising
   supplying a load with power by discharging a high-cycle chemical battery via system terminals of a lead-acid battery and maintaining the voltage at the system terminals essentially equal to a maximum open circuit voltage of the lead-acid battery, until the output voltage of the high-cycle chemical battery has reached an end-of-discharge voltage of the high-cycle chemical battery,
   discharging the lead-acid battery until the voltage of the lead-acid battery has reached an end-of-discharge voltage of the lead-acid battery.
23. Method according to item 22, wherein
   the steps of discharging the high-cycle chemical battery and of discharging the lead-acid battery are executed in parallel.
24. Hybrid battery charging device according to one of items 1 to 8, wherein the charge and discharge control system comprises means for executing the steps of a method according to one of the items 16 to 23.

The embodiments can also be described with a further item list.
1. A battery charging apparatus comprising
   at least two hybrid battery charging devices, each hybrid battery charging device comprising
   input terminals for connecting a photovoltaic panel,
   first battery connections for connecting a lead-acid battery,
   second battery connections for connecting a high-cycle chemical battery,
   a two-way DC/DC converter, wherein a first set of terminals of the two-way DC/DC converter is connected with the second battery connections, and wherein a second set of terminals of the two-way DC/DC converter is connected with the first battery connections,
   a charge and discharge control system, which is connected to the DC/DC converter, and
   output terminals for connecting a load, wherein an input to the output terminals is derived from the first battery connections.
2. The battery charging apparatus according to item 1, wherein the output terminals of the at least two hybrid battery charging devices are connected in parallel.
3. The battery charging apparatus according to item 1 or 2, wherein the input terminals of the at least two hybrid battery charging devices are connected in series.
4. The battery charging apparatus according to one of the above-mentioned items further comprising the high-cycle chemical battery.
5. The battery charging apparatus according to item 4, wherein the high-cycle chemical battery comprises a lithium battery.
6. The battery charging apparatus according to one of the above-mentioned items, wherein
   each hybrid battery charging device further comprises
      a control device which is connected to the charge and discharge control system, wherein input terminals of the control device are connected to the input terminals, and wherein output terminals of the control device are connected to input terminals of the DC/DC converter.
7. The battery charging apparatus according to item 6, wherein the control device comprises a pulse width modulation.
8. The battery charging apparatus according to item 6 or 7, wherein the control device comprises a maximum power point tracker.
9. The battery charging apparatus according to one of items 6 to 8, wherein the control device comprises a controllable switch.
10. The battery charging apparatus according to one of items 6 to 9, wherein the control device comprises a DC/DC converter.
11. The battery charging apparatus according to one of the above-mentioned items, wherein
   the two-way DC/DC converter comprises a buck-boost converter, a buck converter, a boost converter or another converter topology.
12. The battery charging apparatus according to one of the above-mentioned items, wherein
   the two-way DC/DC converter comprises at least two semiconductor switches, wherein respective input connections of the transistors are connected to the charge control system.
13. The battery charging apparatus according to one of the above-mentioned items, wherein
   the hybrid battery charging device comprises
      first voltage measuring connections for connecting a first voltage sensor, the first voltage sensor being connected to terminals of the lead-acid battery and the first voltage measuring connections being connected to the charge and discharge control system,
      second voltage measuring connections for connecting a second voltage sensor, the second voltage sensor being connected to terminals of the high-cycle chemical battery and the second voltage measuring connections being connected to the charge and discharge control system.
14. The battery charging apparatus according to one of the above-mentioned items, wherein
   the hybrid battery charging device comprises
      a separate battery management system for the high-cycle chemical battery, the separate battery management system being connected to the charge and discharge control system.
15. The battery charging apparatus according to item 14, wherein
   one battery management system of one hybrid battery charging device is provided as a master controller and the other battery management system of the other hybrid battery charging device is provided as a slave controller.
16. A storage system comprising
   a battery charging apparatus according to one of the above-mentioned items comprising at least two hybrid battery charging devices and
   a lead-acid battery being connected to the battery charging apparatus.
17. The storage system according to item 16, wherein the hybrid battery charging device comprises a high-cycle chemical battery.
18. The storage system according to item 17, wherein the high-cycle chemical battery comprises a lithium battery.
19. The storage system according to item 17 or 18, wherein one capacitor is connected in parallel to the high-cycle chemical battery.
20. The storage system according to one of items 16 to 19, wherein
   a first voltage sensor is connected to a terminal of first battery connections and to a charge and discharge control system of the hybrid battery charging device, and
   a second voltage sensor is connected to a terminal of second battery connections and to the charge and discharge control system of the hybrid battery charging device.
21. A battery charging apparatus comprising
   at least one hybrid battery charging device, the hybrid battery charging device comprises
   input terminals for connecting a photovoltaic panel,
   first battery connections for connecting a lead-acid battery,
   second battery connections for connecting a high-cycle chemical battery,
   a two-way DC/DC converter with an adjustable voltage conversion ratio, wherein a first set of terminals of the two-way DC/DC converter is connected with the second battery connections, and wherein a second set of terminals of the two-way DC/DC converter is connected with the first battery connections,
   a charge and discharge control system, which is connected to the two-way DC/DC converter (via respective control lines),
   output terminals for connecting a load, wherein an input to the output terminals is derived from the first battery connections,
   wherein
   the charge and discharge control system comprises
   a first device for providing at least one electrical measurement of the lead-acid battery,
   a second device for providing at least one electrical measurement of the high-cycle chemical battery, and
   a processor being adapted to adjust the voltage conversion ratio of the two-way DC/DC converter according to the at least one lead-acid battery electrical measurement and to the at least one high-cycle chemical battery electrical measurement.
22. The battery charging apparatus according to item 21, wherein
   the first device comprises a voltage measurement device.
23. The battery charging apparatus according to item 21 or wherein
   the first device comprises an electrical current measurement device.
24. The battery charging apparatus according to one of items 21 to 23, wherein
   the second device comprises a voltage measurement device.
25. The battery charging apparatus according to one of items 21 to 24, wherein
   the second device comprises an electrical current measurement device.
26. The battery charging apparatus according to one of items 21 to 25, wherein
   (the processor comprises a pre-determined voltage value), the processor is further adapted to control the two-way DC/DC converter according to a pre-determined voltage value.
27. The battery charging apparatus according to one of items 21 to 26, wherein
   the at least one hybrid battery charging device comprises at least two hybrid battery charging devices.
28. The battery charging apparatus according to item 27, wherein
   (output terminals of) the at least two hybrid battery charging devices are connected in parallel.
29. The battery charging apparatus according to item 27, wherein
   (the input terminals of) the at least two hybrid battery charging devices are connected in series.
30. A hybrid storage system comprising
   a battery charging apparatus according to one items 21 to 29, wherein
   the battery charging apparatus comprise at least one hybrid battery charging device, a high-cycle chemical battery which is connected to second battery connections of the hybrid battery charging device.
31. The hybrid storage system according to item 30, wherein the high-cycle chemical battery comprises a lithium battery.
32. The hybrid storage system according to item 30 or 31 further comprising
   a capacitor which is connected in parallel to the high-cycle chemical battery.
33. The hybrid storage system according to one of the items 32 to 34 further comprising
   a lead-acid battery, the lead acid battery being connected to first battery connections of the hybrid battery charging device.
34. A method of operating a battery charging apparatus, the battery charging apparatus comprising at least one hybrid battery charging device, the method comprising
   measuring a lead acid battery,
   measuring a high-cycle chemical battery, wherein a first set of terminals of a two-way DC/DC converter is connected with the high-cycle chemical battery, and wherein a second set of terminals of the two-way DC/DC converter is connected with the lead acid battery, and
   adjusting a voltage conversion ratio of the two-way DC/DC converter according to the lead-acid battery electrical measurement and to the high-cycle chemical battery electrical measurement.
35. The method according to item 34, wherein
   the measurement of the lead acid battery comprises measuring a voltage of the lead acid battery.
36. The method according to item 34 or 35, wherein
   the measurement of the lead acid battery comprises measuring an electrical current of the lead acid battery.
37. The method according to one of items 34 to 36, wherein
   the measurement of the lithium battery comprises measuring a voltage of the lithium battery.
38. The method according to one of items 34 to 37, wherein
   the measurement of the lithium battery comprises measuring an electrical current of the lithium battery.

In the abovementioned description, details have been provided to describe the embodiments of the application. It shall be apparent to one skilled in the art, however, that the embodiments may be practised without such details. For example, there are various circuit arrangements for realizing the components of the hybrid storage system. These circuit arrangements may have additional components or other components with similar functions as those shown in the detailed embodiment. For example, the transistors are shown as n-type unipolar transistors in the embodiments. The skilled person will recognize, however, that the arrangement can also be realized with p-type transistors. Other modifications may arise, for example, from reversing the polarity of the batteries, placing voltage sensors at different locations etc.

### REFERENCE

5 hybrid storage system
6 lithium battery
7 current direction
8 first energy storage subsystem
9 second energy storage subsystem
10 hybrid battery-charging device
11 photovoltaic panel/module
12 lead-acid battery
13 DC/DC converter
14 charge control system
15 microcontroller
16 sensors
17 DC/DC converter
18 voltage monitoring chip
19 load
20 load switch
21 protection MOSFEET
22 MOSFET
23 inductivity
24 MOSFET
25 capacitor
26 capacitor
27 diode
28 diode
29 MOSFET
30 MOSFET
31 MOSFET
32 capacitor
33 capacitor
34 diode
35 diode
36 diode
37 diode
38 ground potential
39 TVS diode
40 positive input terminal
41 negative input terminal
42 positive output terminal
43 negative output terminal
44 positive input terminal
45 negative input terminal
46 positive output terminal
47 negative output terminal
48 fuse
50 step
51 decision step
52 decision step
53 step
54 step
55 decision step
56 step
57 step
100 energy storage device
103a hybrid storage system
103b hybrid storage system
103c hybrid storage system
106a photovoltaic panel
106b photovoltaic panel
106c photovoltaic panel
109 lead acid battery
109a lead acid battery
109b lead acid battery
109c lead acid battery
112 electrical resistive load
116a one-way DC/DC converter
116b one-way DC/DC converter
116c one-way DC/DC converter
120 two-way DC-to-DC converter
120a two-way DC/DC converter
120b two-way DC/DC converter
120c two-way DC/DC converter
124 lithium battery
124a lithium battery
124b lithium battery
124c lithium battery
128a load switch
128b load switch
128c load switch
130-1a output terminal
130-2a output terminal
130-1b output terminal
130-2b output terminal
130-1c output terminal
130-2c output terminal
134-1a first terminal
134-2a first terminal
134-1b first terminal
134-2b first terminal
134-1c first terminal
134-2c first terminal
138-1a second terminal
138-2a second terminal
138-1b second terminal
138-2b second terminal
138-1c second terminal
138-2c second terminal
140a first terminal
140b first terminal
140c first terminal
144-1a input terminal
144-2a input terminal
144-1b input terminal
144-2b input terminal
144-1c input terminal
144-2c input terminal
148a second terminal
148b second terminal
148c second terminal
150 inverter
152-1a first terminal
152-2a second terminal
152-1b first terminal
152-2b second terminal
152-1c first terminal
152-2c second terminal
154a controller
154b controller
154c controller
156 control line
158 controller
158a controller
158b controller
158c controller
203 lead-acid battery measurement device
206 lithium battery measurement device
210 DC-to-DC converter control bus
214 processor
215 memory unit
217 lead-acid battery voltmeter
220 lead-acid battery ammeter
224 lithium battery voltmeter
227 lithium battery ammeter
250 flow chart
254 step
258 step
262 step
266 step
270 step
274 step
280 step

1-38. (canceled)

39. A battery charging apparatus comprising
at least two hybrid battery charging devices, each hybrid battery charging device including:
input terminals for connecting a photovoltaic panel;
first battery connections for connecting a lead-acid battery;
second battery connections for connecting a high-cycle chemical battery;
a two-way DC/DC converter, wherein a first set of terminals of the two-way DC/DC converter is connected with the second battery connections, and wherein a second set of terminals of the two-way DC/DC converter is connected with the first battery connections;
a charge and discharge control system, which is connected to the two-way DC/DC converter; and
output terminals for connecting a load, wherein an input to the output terminals is derived from the first battery connections.

40. The battery charging apparatus according to claim 39, wherein the output terminals of the at least two hybrid battery charging devices are connected in parallel.

41. The battery charging apparatus according to claim 39, wherein the input terminals of the at least two hybrid battery charging devices are connected in series.

42. The battery charging apparatus according to claim 39 further comprising the high-cycle chemical battery.

43. The battery charging apparatus according to claim 42, wherein the high-cycle chemical battery comprises a lithium battery.

44. The battery charging apparatus according to claim 39, wherein each hybrid battery charging device further comprises a control device which is connected to the charge and discharge control system, wherein input terminals of the control device are connected to the input terminals, and wherein output terminals of the control device are connected to input terminals of the two-way DC/DC converter.

45. The battery charging apparatus according to claim 44, wherein the control device comprises a pulse width modulation.

46. The battery charging apparatus according to claim 44, wherein the control device comprises a maximum power point tracker.

47. The battery charging apparatus according to claim 44, wherein the control device comprises a controllable switch.

48. The battery charging apparatus according to claim 44, wherein the control device comprises a one-way DC/DC converter.

49. The battery charging apparatus according to claim 39, wherein the two-way DC/DC converter comprises a buck-boost converter, a buck converter, a boost converter or another converter topology.

50. The battery charging apparatus according to claim 39, wherein the two-way DC/DC converter comprises at least two semi-conductor switches, wherein respective input connections of the transistors are connected to the charge control system.

51. The battery charging apparatus according to claim 39, wherein the hybrid battery charging devices further include:
first voltage measuring connections for connecting a first voltage sensor, the first voltage sensor being connected to terminals of the lead-acid battery and the first voltage measuring connections being connected to the charge and discharge control system,
second voltage measuring connections for connecting a second voltage sensor, the second voltage sensor being connected to terminals of the high-cycle chemical battery and the second voltage measuring connections being connected to the charge and discharge control system.

52. The battery charging apparatus according to claim 39, wherein the hybrid battery charging devices further include:
a separate battery management system for the high-cycle chemical battery, the separate battery management system being connected to the charge and discharge control system.

53. The battery charging apparatus according to claim 53, wherein one battery management system of one of the hybrid battery charging devices is provided as a master controller and the other battery management system of the other of the hybrid battery charging devices is provided as a slave controller.

54. A storage system, comprising:
a battery charging apparatus including at least two hybrid battery charging devices, each hybrid battery charging device including input terminals for connecting a photovoltaic panel, first battery connections for connecting a lead-acid battery, second battery connections for connecting a high-cycle chemical battery, a two-way DC/DC converter, wherein a first set of terminals of the two-way DC/DC converter is connected with the second battery connections, and wherein a second set of terminals of the two-way DC/DC converter is connected with the first battery connections, a charge and discharge control system, which is connected to the two-way DC/DC converter, and output terminals for connecting a load, wherein an input to the output terminals is derived from the first battery connections; and
a lead-acid battery being connected to the battery charging apparatus.

55. The storage system according to claim 54, wherein the hybrid battery charging devices further include a high-cycle chemical battery.

56. The storage system according to claim 55, wherein the high-cycle chemical battery includes a lithium battery.

57. The storage system according to claim 55, wherein one capacitor is connected in parallel to the high-cycle chemical battery.

58. The storage system according to claim 54, wherein a first voltage sensor is connected to a terminal of first battery connections and to a charge and discharge control system of the hybrid battery charging device, and a second voltage sensor is connected to a terminal of second battery connections and to the charge and discharge control system of the hybrid battery charging device.

59. A battery charging apparatus, comprising:
at least one hybrid battery charging device, the hybrid battery charging device including:
input terminals for connecting a photovoltaic panel,
first battery connections for connecting a lead-acid battery,
second battery connections for connecting a high-cycle chemical battery,
a two-way DC/DC converter with an adjustable voltage conversion ratio, wherein a first set of terminals of the two-way DC/DC converter is connected with the second battery connections, and wherein a second set of terminals of the two-way DC/DC converter is connected with the first battery connections,
a charge and discharge control system, which is connected to the two-way DC/DC converter, and
output terminals for connecting a load, wherein an input to the output terminals is derived from the first battery connections,
wherein the charge and discharge control system includes a first device for providing at least one electrical measurement of the first battery connections, a second device for providing at least one electrical measurement of the second battery connections, and a processor being adapted to adjust the voltage conversion ratio of the two-way DC/DC converter according to the at least one lead-acid battery electrical measurement and to the at least one high-cycle chemical battery electrical measurement.

60. The battery charging apparatus according to claim 59, wherein the first device comprises a voltage measurement device.

61. The battery charging apparatus according to claim 59, wherein the first device comprises an electrical current measurement device.

62. The battery charging apparatus according to claim 59, wherein the second device comprises a voltage measurement device.

63. The battery charging apparatus according to claim 59, wherein the second device comprises an electrical current measurement device.

64. The battery charging apparatus according to claim 59, wherein the processor is further adapted to control the two-way DC/DC converter according to a pre-determined voltage value.

65. The battery charging apparatus according to claim 59, wherein the at least one hybrid battery charging device comprises at least two hybrid battery charging devices.

66. The battery charging apparatus according to claim 65, wherein the at least two hybrid battery charging devices are connected in parallel.

67. The battery charging apparatus according to claim 65, wherein the at least two hybrid battery charging devices are connected in series.

68. A hybrid storage system, comprising:
a battery charging apparatus having at least one hybrid battery charging device, the hybrid battery charging device including:
input terminals for connecting a photovoltaic panel,
first battery connections for connecting a lead-acid battery,
second battery connections for connecting a high-cycle chemical battery,
a two-way DC/DC converter with an adjustable voltage conversion ratio, wherein a first set of terminals of the two-way DC/DC converter is connected with the second battery connections, and wherein a second set of terminals of the two-way DC/DC converter is connected with the first battery connections,
a charge and discharge control system, which is connected to the two-way DC/DC converter, and
output terminals for connecting a load, wherein an input to the output terminals is derived from the first battery connections,
wherein the charge and discharge control system includes a first device for providing at least one electrical measurement of the first battery connections, a second device for providing at least one electrical measurement of the second battery connections, and a processor being adapted to adjust the voltage conversion ratio of the two-way DC/DC converter according to the at least one lead-acid battery electrical measurement and to the at least one high-cycle chemical battery electrical measurement; and
wherein the hybrid storage system further comprises a high-cycle chemical battery which is connected to second battery connections of the hybrid battery charging device.

69. The hybrid storage system according to claim 68, wherein the high-cycle chemical battery comprises a lithium battery.

70. The hybrid storage system according to claim 68, further comprising:
a capacitor which is connected in parallel to the high-cycle chemical battery.

71. The hybrid storage system according to claim 68, further comprising:
a lead-acid battery being connected to first battery connections of the hybrid battery charging device.

72. A method of operating a battery charging apparatus, the battery charging apparatus including at least one hybrid battery charging device, the method comprising:
measuring a lead acid battery;
measuring a high-cycle chemical battery, wherein a first set of terminals of a two-way DC/DC converter is connected with the high-cycle chemical battery, and wherein a second set of terminals of the two-way DC/DC converter is connected with the lead acid battery; and
adjusting a voltage conversion ratio of the two-way DC/DC converter according to the lead-acid battery electrical measurement and to the high-cycle chemical battery electrical measurement.

73. The method according to claim 72, wherein the measurement of the lead acid battery comprises measuring a voltage of the lead acid battery.

74. The method according to claim 72, wherein the measurement of the lead acid battery comprises measuring an electrical current of the lead acid battery.

75. The method according to claim 72, wherein the measurement of the lithium battery comprises measuring a voltage of the lithium battery.

76. The method according to claim 72, wherein the measurement of the lithium battery comprises measuring an electrical current of the lithium battery.
